(19) United States
(12) Patent Application Publication
(10) Pub. No.: US 2019/0129024 A1
(43) Pub. Date: May 2, 2019

(54) PATH SELECTION FOR FINE TIMING MEASUREMENT PROTOCOL

(71) Applicant: QUALCOMM Incorporated, San Diego, CA (US)

(72) Inventors: Assaf Yaakov KASHER, Haifa (IL); Alecsander Petru EITAN, Haifa (IL); Amichai SANDEROVICH, Atlit (IL); Solomon TRAININ, Haifa (IL)

(21) Appl. No.: 16/175,713

(22) Filed: Oct. 30, 2018

Related U.S. Application Data
(60) Provisional application No. 62/579,781, filed on Oct. 31, 2017.

(51) Int. Cl. G01S 13/76; G01S 7/00

(52) U.S. Cl. CPC G01S 13/765; G01S 7/006; G01S 13/767

(57) ABSTRACT

An apparatus may identify a first set of antenna settings and a second set of antenna settings based on beamforming training with a second apparatus, the first set of antenna settings corresponding to a first path with the second apparatus different from a second path with the second apparatus corresponding to the second set of antenna settings. The apparatus may generate a first frame including an indication to use the first path instead of the second path for at least a portion of a fine timing measurement (FTM) session. The apparatus may transmit the first frame for transmission to the second apparatus. The apparatus may receive, from the second apparatus based on the first set of antenna settings, a plurality of FTM measurement frames associated with the at least the portion of the FTM session.

### CROSS-REFERENCE TO RELATED APPLICATION(S)

This application claims the benefit of U.S. Provisional Application Ser. No. 62/579,781, entitled “PATH SELECTION FOR FINE TIMING MEASUREMENT PROTOCOL” and filed on Oct. 31, 2017, which is expressly incorporated by reference herein in its entirety.

### BACKGROUND

### Field

The present disclosure relates generally to communication systems, and more particularly, to a wireless apparatus configured to determine a position of the wireless apparatus.

### Introduction

Communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As communication networks become increasingly populated by wireless nodes, more efficient approaches for determination or estimation of location or position information may be needed. The disclosure below describes approaches for more efficiently determining or estimating a location or position of a wireless apparatus using a fine timing measurement (FTM) protocol. The FTM protocol may provide a protocol for location/position determination/estimation using timing measurement frames that may provide an increased resolution, e.g., in comparison to other approaches that may be based on timing. For example, the FTM protocol may provide timing resolution with an order of magnitude in picoseconds and/or nanoseconds. Such an order of magnitude may be more precise than existing approaches, which may translate to more precise location/position determination/estimation.

In an aspect of the disclosure, an apparatus for wireless communication is provided. The apparatus may include a processing system configured to identify a first set of antenna settings and a second set of antenna settings based on beamforming training with a second apparatus, the first set of antenna settings corresponding to a first path with the second apparatus different from than a second path with the second apparatus corresponding to the second set of antenna settings, and generate a first frame including an indication to use the first path instead of the second path for at least a portion of an FTM session. The apparatus may include a first interface configured to output the first frame for transmission to the second apparatus. The apparatus may include a second interface configured to obtain, from the second apparatus based on the first set of antenna settings, a plurality of FTM measurement frames associated with the at least the portion of the FTM session. In an aspect, the first frame comprises a trigger field associated with the FTM session, and the indication to use the first path instead of the second path comprises a value of the trigger field. In an aspect, the processing system is further configured to generate a second frame including acknowledgement information associated with a first FTM measurement frame of the plurality of FTM measurement frames and including one or more training (TRN) fields, and the first interface is further configured to output the second frame for transmission to the second apparatus using the first set of antenna settings. In an aspect, a second FTM measurement frame of the plurality of FTM measurement frames indicates at least one of a time of arrival associated with the second frame or a time of departure associated with the first FTM measurement frame, and the processing system is further configured to determine a position of the apparatus based at least partially on the at least one of the time of arrival or the time of departure. In an aspect, the second FTM measurement frame indicates at least one of an angle of arrival associated with the second frame or an angle of departure associated with the second FTM measurement frame, and the processing system is further configured to determine the position of the apparatus based at least partially on the at least one of the angle of arrival or the angle of departure. In an aspect, the processing system is further configured to generate a third frame including an indication to use the second path instead of the first path after the FTM session, and the first interface is further configured to output the third frame for transmission to the second apparatus. In an aspect, the third frame comprises a contention-free (CF) end frame or an FTM request frame indicating termination of the FTM session.

In an aspect of the disclosure, an apparatus for wireless communication is provided. The apparatus may include a first interface configured to obtain a first frame including an indication to use a first path with a second apparatus for at least a portion of an FTM session, the first path different from than a second path with the second apparatus. The apparatus may include a processing system configured to identify, based on beamforming training with the second apparatus, a first set of antenna settings corresponding to the first path with the second apparatus and a second set of antenna settings corresponding to the second path with the second apparatus, select, based on the indication to use the first path, the first set of antenna settings instead of the second set of antenna settings, and generate a plurality of FTM measurement frames associated with the FTM session. The apparatus may include a second interface configured to output each FTM measurement frame of the plurality of FTM measurement frames for transmission using the first set of antenna settings. In an aspect, the first frame comprises a trigger field associated with the FTM session, the indication to use the first path instead of the second path comprises a value of the trigger field, and the selection of the first set of antenna settings instead of the second set of antenna settings is based on the value of the trigger field. In an aspect, the first interface is further configured to obtain, from the second apparatus using the first set of antenna settings, a second frame including acknowledgement information associated with a first FTM measurement frame of the plurality of FTM measurement frames and including one or more TRN fields, and the generation of the plurality of FTM measurement frames comprises generating a second FTM measurement frame that indicates at least one of a time of arrival associated with the second frame or a time of departure associated with the first FTM measurement frame. In an aspect, the second FTM measurement frame indicates at least one of an angle of arrival associated with the second frame or an angle of departure associated with the second FTM measurement frame. In an aspect, the first interface is further configured to obtain a third frame including an indication to use the second path instead of the first path after the FTM session, the processing system is further configured to select, based on the indication to use the second path, the second set of antenna settings for communication with the second apparatus after the FTM session. In an aspect, the third frame comprises a CF end frame or an FTM request frame indicating termination of the FTM session.

In an aspect of the disclosure, an apparatus for wireless communication is provided. The apparatus may include means for identifying a first set of antenna settings and a second set of antenna settings based on beamforming training with a second apparatus, the first set of antenna settings corresponding to a first path with the second apparatus different from than a second path with the second apparatus corresponding to the second set of antenna settings. The apparatus may include means for generating a first frame including an indication to use the first path instead of the second path for at least a portion of an FTM session. The apparatus may include means for outputting the first frame for transmission to the second apparatus. The apparatus may include means for obtaining, from the second apparatus based on the first set of antenna settings, a plurality of FTM measurement frames associated with the at least the portion of the FTM session. In an aspect, the first frame comprises a trigger field associated with the FTM session, and the indication to use the first path instead of the second path comprises a value of the trigger field. The apparatus may include means for generating a second frame including acknowledgement information associated with a first FTM measurement frame of the plurality of FTM measurement frames and including one or more TRN fields, and means for outputting the second frame for transmission to the second apparatus using the first set of antenna settings. In an aspect, a second FTM measurement frame of the plurality of FTM measurement frames indicates at least one of a time of arrival associated with the second frame or a time of departure associated with the first FTM measurement frame, and the apparatus further comprises means for determining a position of the apparatus based at least partially on the at least one of the time of arrival or the time of departure. In an aspect, the second FTM measurement frame indicates at least one of an angle of arrival associated with the second frame or an angle of departure associated with the second FTM measurement frame, and the apparatus further comprises means for determining a position of the apparatus based at least partially on the at least one of the angle of arrival or the angle of departure. The apparatus may further include means for generating a third frame including an indication to use the second path instead of the first path after the FTM session, and means for outputting the third frame for transmission to the second apparatus. In an aspect, the third frame comprises a CF end frame or an FTM request frame indicating termination of the FTM session.

In an aspect of the disclosure, an apparatus for wireless communication is provided. The apparatus may include means for obtaining a first frame including an indication to use a first path with a second apparatus for at least a portion of an FTM session, the first path different from than a second path with the second apparatus. The apparatus may include means for identifying, based on beamforming training with the second apparatus, a first set of antenna settings corresponding to the first path with the second apparatus and a second set of antenna settings corresponding to the second path with the second apparatus. The apparatus may include means for selecting, based on the indication to use the first path, the first set of antenna settings instead of the second set of antenna settings. The apparatus may include means for generating a plurality of FTM measurement frames associated with the FTM session. The apparatus may include means for outputting each FTM measurement frame of the plurality of FTM measurement frames for transmission using the first set of antenna settings. In an aspect, the first frame comprises a trigger field associated with the FTM session, the indication to use the first path instead of the second path comprises a value of the trigger field, and the selection of the first set of antenna settings instead of the second set of antenna settings is based on the value of the trigger field. The apparatus may include means for obtaining, from the second apparatus using the first set of antenna settings, a second frame including acknowledgement information associated with a first FTM measurement frame of the plurality of FTM measurement frames and including one or more TRN fields, wherein the means for generating the plurality of FTM measurement frames is configured to generate a second FTM measurement frame that indicates at least one of a time of arrival associated with the second frame or a time of departure associated with the first FTM measurement frame. In an aspect, the second FTM measurement frame indicates at least one of an angle of arrival associated with the second frame or an angle of departure associated with the second FTM measurement frame. The apparatus may include means for obtaining a third frame including an indication to use the second path instead of the first path after the FTM session; and means for selecting, based on the indication to use the second path, the second set of antenna settings for communication with the second apparatus after the FTM session. In an aspect, the third frame comprises a CF end frame or an FTM request frame indicating termination of the FTM session.

In an aspect of the disclosure, a method for wireless communication by an apparatus is provided. The method may include identifying a first set of antenna settings and a second set of antenna settings based on beamforming training with a second apparatus, the first set of antenna settings corresponding to a first path with the second apparatus different from than a second path with the second apparatus corresponding to the second set of antenna settings. The method may include generating a first frame including an indication to use the first path instead of the second path for at least a portion of an FTM session. The method may include outputting the first frame for transmission to the second apparatus. The method may include obtaining, from the second apparatus based on the first set of antenna settings, a plurality of FTM measurement frames associated with the at least the portion of the FTM session. In an aspect, the first frame comprises a trigger field associated with the FTM session, and the indication to use the first path instead of the second path comprises a value of the trigger field. The method may include generating a second frame including acknowledgement information associated with a first FTM measurement frame of the plurality of FTM measurement frames and including one or more TRN fields. The method may include outputting the second frame for transmission to the second apparatus using the first set of antenna settings. In an aspect, a second FTM measurement frame of the plurality of FTM measurement frames indicates at least one of a time of arrival associated with the second frame or a time of departure associated with the first FTM measurement frame, and the method further comprising: determining a position of the apparatus based at least partially on the at least one of the time of arrival or the time of departure. In an aspect, the second FTM measurement frame indicates at least one of an angle of arrival associated with the second frame or an angle of departure associated with the second FTM measurement frame, and the method further comprises determining a position of the apparatus based at least partially on the at least one of the angle of arrival or the angle of departure. The method may further include generating a third frame including an indication to use the second path instead of the first path after the FTM session, and outputting the third frame for transmission to the second apparatus. In an aspect, the third frame comprises a CF end frame or an FTM request frame indicating termination of the FTM session.

In an aspect of the disclosure, a method for wireless communication by an apparatus is provided. The method may include obtaining a first frame including an indication to use a first path with a second apparatus for at least a portion of an FTM session, the first path different from than a second path with the second apparatus. The method may include identifying, based on beamforming training with the second apparatus, a first set of antenna settings corresponding to the first path with the second apparatus and a second set of antenna settings corresponding to the second path with the second apparatus. The method may include selecting, based on the indication to use the first path, the first set of antenna settings instead of the second set of antenna settings. The method may include generating a plurality of FTM measurement frames associated with the FTM session. The method may include outputting each FTM measurement frame of the plurality of FTM measurement frames for transmission using the first set of antenna settings. In an aspect, the first frame comprises a trigger field associated with the FTM session, the indication to use the first path instead of the second path comprises a value of the trigger field, and the selecting of the first set of antenna settings instead of the second set of antenna settings is based on the value of the trigger field. The method may include obtaining, from the second apparatus using the first set of antenna settings, a second frame including acknowledgement information associated with a first FTM measurement frame of the plurality of FTM measurement frames and including one or more TRN fields, wherein the generating the plurality of FTM measurement frames comprises generating a second FTM measurement frame that indicates at least one of a time of arrival associated with the second frame or a time of departure associated with the first FTM measurement frame. In an aspect, the second FTM measurement frame indicates at least one of an angle of arrival associated with the second frame or an angle of departure associated with the second FTM measurement frame. The method may include obtaining a third frame including an indication to use the second path instead of the first path after the FTM session, and selecting, based on the indication to use the second path, the second set of antenna settings for communication with the second apparatus after the FTM session. In an aspect, the third frame comprises a CF end frame or an FTM request frame indicating termination of the FTM session.

In an aspect of the disclosure, a computer-readable medium comprising codes for wireless communication executable by an apparatus is provided. The computer-readable medium may comprise codes to cause an apparatus to identify a first set of antenna settings and a second set of antenna settings based on beamforming training with a second apparatus, the first set of antenna settings corresponding to a first path with the second apparatus different from than a second path with the second apparatus corresponding to the second set of antenna settings; generate a first frame including an indication to use the first path instead of the second path for at least a portion of an FTM session; output the first frame for transmission to the second apparatus; and obtain, from the second apparatus based on the first set of antenna settings, a plurality of FTM measurement frames associated with the at least the portion of the FTM session.

In an aspect of the disclosure, a computer-readable medium comprising codes for wireless communication executable by an apparatus is provided. The computer-readable medium may comprise codes to cause an apparatus to obtain a first frame including an indication to use a first path with a second apparatus for at least a portion of an FTM session, the first path different from than a second path with the second apparatus; identify, based on beamforming training with the second apparatus, a first set of antenna settings corresponding to the first path with the second apparatus and a second set of antenna settings corresponding to the second path with the second apparatus; select, based on the indication to use the first path, the first set of antenna settings instead of the second set of antenna settings; generate a plurality of FTM measurement frames associated with the FTM session; and output each FTM measurement frame of the plurality of FTM measurement frames for transmission using the first set of antenna settings.

In an aspect of the disclosure, a wireless node is provided. The wireless node may include a processing system configured to: identify a first set of antenna settings and a second set of antenna settings based on beamforming training with a second apparatus, the first set of antenna settings corresponding to a first path with the second apparatus different from than a second path with the second apparatus corresponding to the second set of antenna settings, and generate a first frame including an indication to use the first path instead of the second path for at least a portion of an FTM session. The wireless node may include a transmitter configured to transmit the first frame to the second apparatus. The wireless node may include a receiver configured to receive, from the second apparatus based on the first set of antenna settings, a plurality of FTM measurement frames associated with the at least the portion of the FTM session.

In an aspect of the disclosure, a wireless node is provided. The wireless node may include a receiver configured to receive a first frame including an indication to use a first path with a second apparatus for at least a portion of an FTM session, the first path different from than a second path with the second apparatus. The wireless node may include a processing system configured to identify, based on beamforming training with the second apparatus, a first set of antenna settings corresponding to the first path with the second apparatus and a second set of antenna settings corresponding to the second path with the second apparatus, select, based on the indication to use the first path, the first set of antenna settings instead of the second set of antenna settings, and generate a plurality of FTM measurement frames associated with the FTM session. The wireless node may include a transmitter configured to transmit each FTM measurement frame of the plurality of FTM measurement frames using the first set of antenna settings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 illustrates a diagram of signal propagation in an implementation of phased-array antennas, in accordance with certain aspects of the present disclosure.

FIG. 4 illustrates a call flow diagram of a fine timing measurement (FTM) protocol, in accordance with certain aspects of the present disclosure.

FIG. 5 illustrates a diagram of wireless communications system, in accordance with certain aspects of the disclosure.

FIG. 6 shows an example functional block diagram of a wireless device configured as an initiator using an FTM protocol, in accordance with certain aspects of the present disclosure.

FIG. 7 shows an example functional block diagram of a wireless device configured as a responder using an FTM protocol, in accordance with certain aspects of the present disclosure.

FIG. 8 is a flowchart of an example method of initiating an FTM session, in accordance with certain aspects of the present disclosure.

FIG. 9 illustrates exemplary means capable of performing the operations set forth in FIG. 8, in accordance with certain aspects of the present disclosure.

FIG. 10 is a flowchart of an example method of responding in an FTM session, in accordance with certain aspects of the present disclosure.

FIG. 11 illustrates exemplary means capable of performing the operations set forth in FIG. 10, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

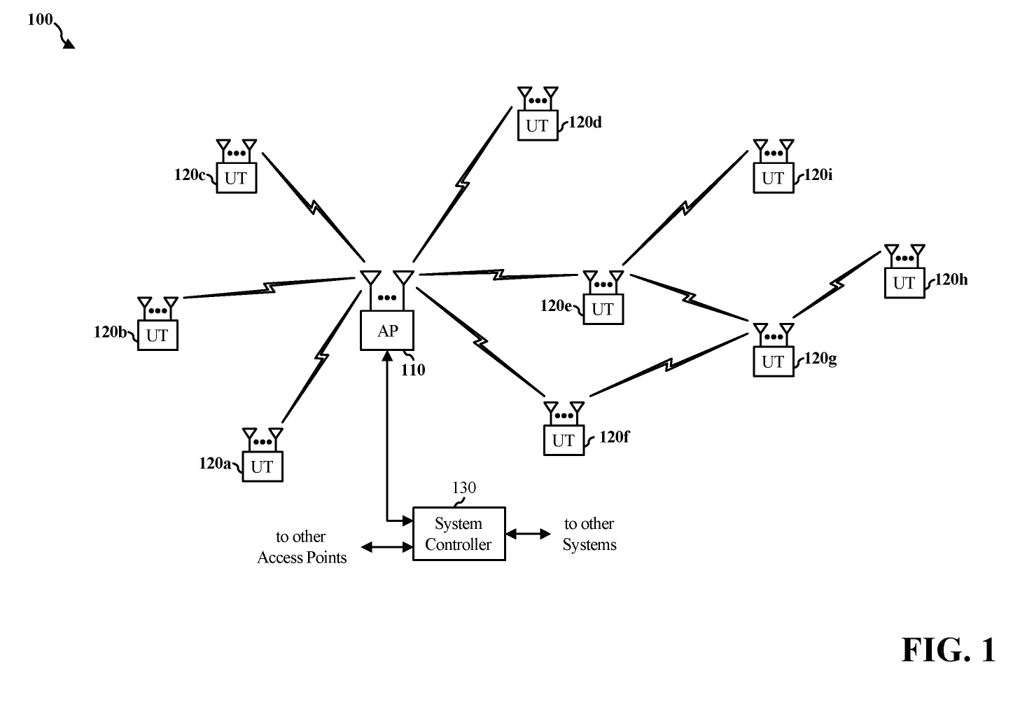

FIG. 1 illustrates a multiple-access multiple-input multiple-output (MIMO) system 100 with access points and user terminals in which aspects of the present disclosure may be practiced. For example, one or more user terminals 120 may signal capabilities (e.g., to access point 110) using the techniques provided herein.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless node, a wireless node, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≥K≥1 if the data symbol streams for the K user terminals are not multiplexed in code, frequency or time by some means. K may be greater than Nₐₚ if symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

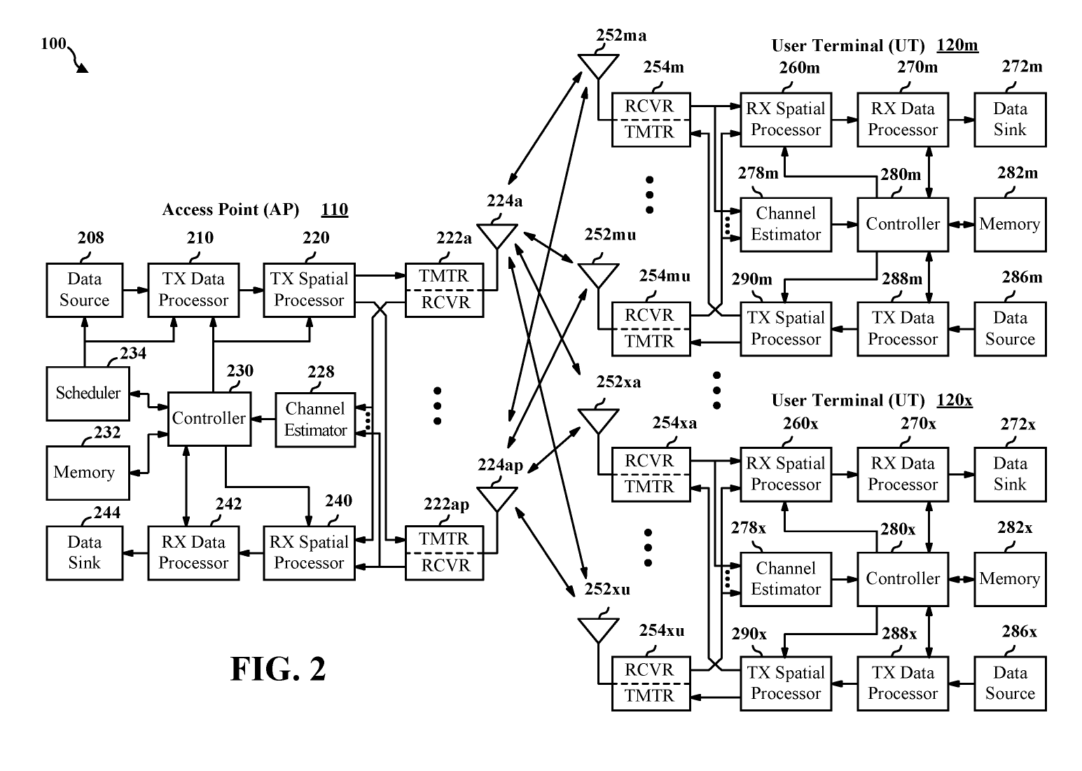

FIG. 2 illustrates a block diagram of access point 110 and two user terminals 120m and 120x in MIMO system 100 that may be examples of the access point 110 and user terminals 120 described above with reference to FIG. 1 and capable of performing the techniques described herein. The various processors shown in FIG. 2 may be configured to perform (or direct a device to perform) various methods described herein.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals are simultaneously transmitted to on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N^{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, signal-to-noise ratio (SNR) estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

Certain standards, such as the IEEE 802.11ay standard currently in the development phase, extend wireless communications according to existing standards (e.g., the 802.11ad standard) into the 60 gigahertz (GHz) band. Example features to be included in such standards include channel aggregation and Channel-Bonding (CB). In general, channel aggregation utilizes multiple channels that are kept separate, while channel bonding treats the bandwidth of multiple channels as a single (wideband) channel.

Operations in the 60 GHz band may allow the use of smaller antennas as compared to lower frequencies. While radio waves around the 60 GHz band have relatively high atmospheric attenuation, the higher free space loss can be compensated for by using many small antennas, for example, arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

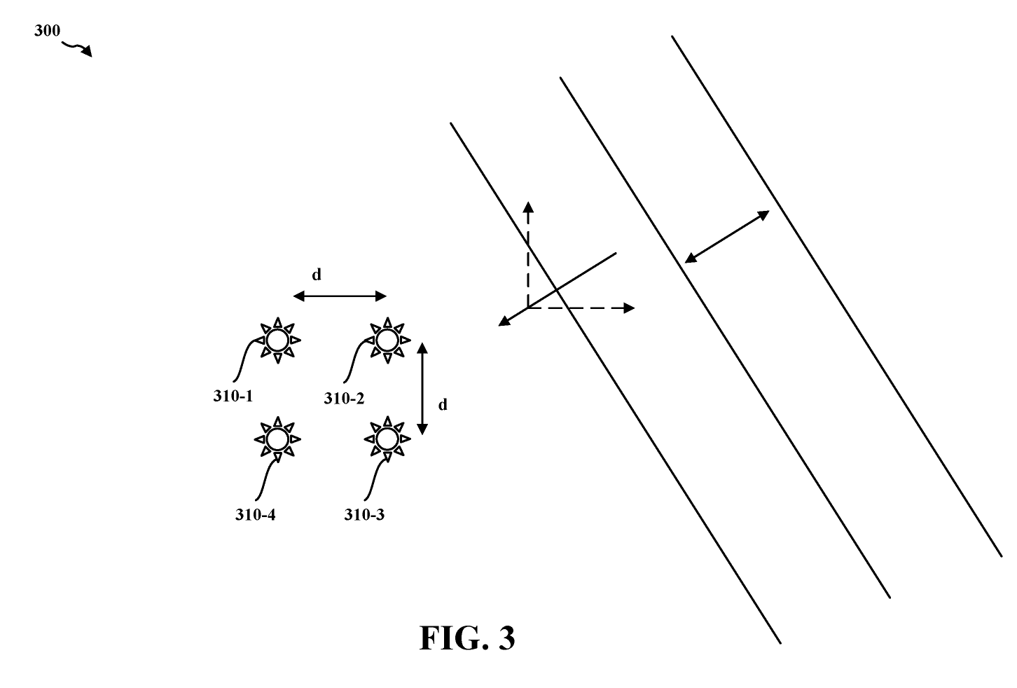

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

### Example Fine Timing Measurement (FTM) Session

Aspects of the present disclosure may provide for positioning determination based on timing measurement. The aspects described herein may use an FTM protocol with a timing resolution that is more precise than existing approaches. Various approaches described herein may allow a wireless apparatus (e.g., an STA) to determine the position of the wireless apparatus by utilizing communication according to an FTM protocol. The FTM protocol may include an exchange of a plurality of frames that are respectively timestamped. As used herein, “position” may refer to “location” and/or “orientation,” either relative to some point of reference or absolute (e.g., earth or geographic coordinates), and may include angles of elevation and azimuth.

According to various standards and specifications, such as IEEE 802.11, wireless apparatuses may be configured to determine (e.g., estimate) a position (e.g., location) of the wireless apparatus. Examples of approaches to determination of a position of a wireless apparatus may be based on round trip time (RTT), angle of arrival (AoA), and/or angle of departure (AoD). According to various aspects, one responder (e.g., AP or another STA) may be sufficient for position determination if both RTT, angular information (e.g., AoA and/or AoD), and/or the location of the responder is available based on communication with the one responder. In other aspects, position determination may be based on input from two responders (e.g., for two dimensions) and/or three responders (e.g., for three dimensions).

According to the FTM protocol, an exchange of a plurality of frames between a wireless apparatus (e.g., initiator) and a remote apparatus (e.g., responder) may enable position determination based on respective timestamps of the exchanged frames. In some aspects, angular information (e.g., AoA and/or AoD information) may be additionally leveraged for position determination.

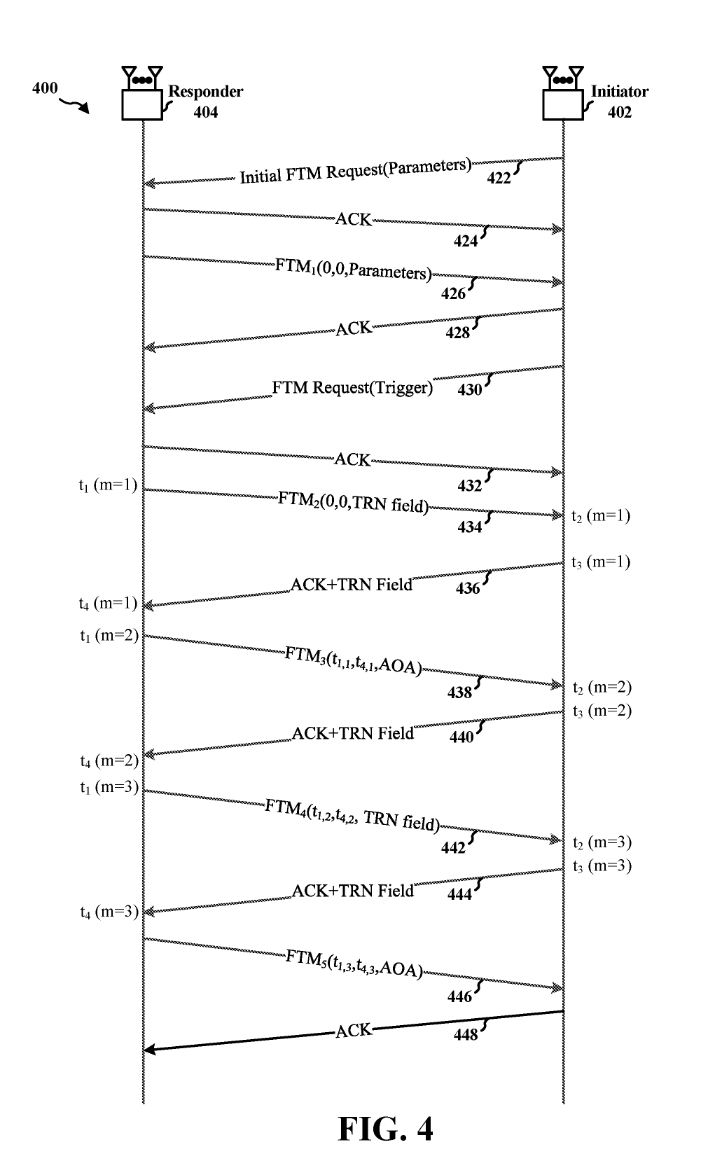

FIG. 4 is a call flow diagram illustrating a frame exchange according to the FTM protocol. As illustrated, an initiator 402 and a responder 404 may perform the frame exchange according to the FTM protocol. At least a portion of the illustrated frame exchange according to the FTM protocol may be herein referred to as an “FTM session.”

In aspects, the initiator 402 may be a wireless apparatus, such as UT 120, an STA, or another wireless communications apparatus. The responder 404 may be another wireless apparatus that is remote from the initiator 402. For example, the responder 404 may be a UT 120, an AP 110, another STA, or another wireless communications apparatus configured to perform the operations described herein.

According to aspects, the initiator 402 may begin an FTM session by transmitting, to the responder 404, an initial FTM request frame 422. The initial FTM request frame 422 may include information indicating a duration of the FTM session, the amount and/or type of FTM data that may be exchanged, and/or other parameters. Examples of the parameters that may be included in the initial FTM request frame 422 may include a number of FTM measurement frames that are to be exchanged, a duration of an FTM measurement frame, the number of FTM measurement frames per burst, the number of bursts per FTM session, and/or other parameters relating to the FTM session.

In aspects, the responder 404 may indicate that the responder 404 intends to participate in the FTM session and accepts the parameters indicated in the initial FTM request frame 422. For example, the responder 404 may transmit an acknowledgement (ACK) message 424 to the initiator 402. In some aspects, the responder 404 may transmit, to the initiator 402, a first FTM measurement frame 426. The responder 404 may indicate, in the first FTM measurement frame 426, whether the request to initiate the FTM session (as indicated by the initial FTM request frame 422) succeeded or failed, whether one or more parameters indicated by the initial FTM request frame 422 are accepted, and the like. In some aspects, the responder 404 may optionally designate and/or renegotiate one or more parameters associated with the FTM session and may indicate the same to the initiator 402 in the first FTM measurement frame 426. In some aspects, the responder 404 may include location information indicating a location of the responder 404 in frame 426. In some aspects, the ACK message 424 and the first FTM measurement frame 426 may be included in a same frame. In some aspects, the responder 404 may indicate a time of arrival (ToA) of the initial FTM request frame 422 and/or a time of departure (ToD) of the first FTM measurement frame 426. For example, the responder 404 may indicate a zero (0) for both the ToA and ToD in the first FTM measurement frame 426 (e.g., because the timing measurement portion of the FTM session has not yet been triggered).

In response to the first FTM measurement frame 426, the initiator 402 may transmit an ACK message 428. The initiator 402 may indicate, in the ACK message 428, that the initiator 402 has accepted one or more parameters indicated by the first FTM measurement frame 426. The ACK message 428 may conclude a negotiation portion of the FTM session.

In some aspects, one or more of the frames 422, 426 and/or messages 424, 428 may include timing synchronization information. The inclusion of timing synchronization information may allow the initiator 402 and/or the responder 404 to synchronize timing so that ToA and ToD information is consistent. For example, the timing synchronization information may allow the initiator 402 and/or responder to synchronize a respective clock and/or cycle. In other aspects, timing synchronization information may be included in another frame (e.g., the FTM request frame 430, the second FTM measurement frame 434, or another frame).

In order to begin the measurement portion of the FTM session, the initiator 402 may transmit an FTM request frame 430. The FTM request frame 430 may “trigger” a measurement portion of the FTM session. In aspects, the FTM request frame 430 may include a trigger field. In some aspects, the initiator 402 may set a value of the trigger field.

Conventionally, the FTM session may be performed using a set of antenna settings (e.g., one or more antenna weight vectors) that may correspond to a path between the initiator 402 and the responder 404 having a best channel quality (e.g., a higher SNR relative to one or more other paths, a lower attenuation relative to one or more other paths, etc.). When using the set of antenna settings corresponding to the “best” path, the initiator 402 may set the value of the trigger field to “0” or “1.” However, the initiator 402 may be configured to set the value of the trigger field to another value, such as a “2.”

As described in the present disclosure, the initiator 402 may set the value of the trigger field to a predefined value in order to indicate to the responder 404 that at least the measurement portion of the FTM session is to occur on a first path instead of the “best” path. For example, the first path may be relatively more direct (e.g., relatively shorter distance, relatively fewer reflections, etc.) than the best path, even though the best path may correspond to a relatively better channel quality than the first path. As described in the present disclosure, the measurement portion of the FTM session may be relatively more accurate using the first path instead of the best path, for example, because the first path may be more direct than the best path (e.g., the first path may be an LoS path).

Upon receiving the FTM request frame 430, the responder 404 may respond with an ACK message 432. The responder 404 may transmit, to the initiator 402, a second FTM measurement frame 434. The responder 404 may record the ToD time t_{1,1} corresponding to the second FTM measurement frame 434 (e.g., time t_{1,1} may correspond to the end of the second FTM measurement frame 434). The responder 404 may indicate, in the second FTM measurement frame 434, a ToA and/or a ToD. In one aspect, the ToA and/or the ToD may be set to zero (0). In aspects, the second FTM measurement frame 434 may include at least one training (TRN) field, which may be appended to the end of the second FTM measurement frame 434. A TRN field may be associated with beamforming for the initiator 402 and the responder 404. In aspects, the at least one TRN field may comprise a TRN unit and/or TRN subfield(s) carrying a set of Golay sequences.

Based on reception of the second FTM measurement frame 434, the initiator 402 may record the ToA time t_{2,1} at which the second FTM measurement frame 434 is received at the initiator 402. For example, the ToA time t_{2,1} may correspond to the at least one TRN field appended at the end of the second FTM measurement frame 434.

Responsive to reception of the second FTM measurement frame 434, the initiator 402 may transmit a first ACK frame 436. In aspects, the initiator 402 may append at least one TRN field to the first ACK frame 436. Based on transmission of the first ACK frame 436, the initiator 402 may record the ToD time t_{3,1} at which the initiator 402 transmits the first ACK frame 436 (e.g., the ToD time t_{3,1} may correspond to a beginning of the first ACK frame 436).

Based on reception of the first ACK frame 436, the responder 404 may record the ToA time t_{4,1} at which the first ACK frame 436 is received at the responder 404 (e.g., time t_{4,1} may correspond to the beginning of the first ACK frame 436 using the channel estimate field following the short training field). The responder 404 may then transmit, to the initiator 402, a third FTM measurement frame 438. The third FTM measurement frame 438 may indicate the ToD time t_{1,1} recorded for the second FTM measurement frame 434 and the ToA time t_{4,1} recorded for the first ACK frame 436. In association with the next FTM measurement burst, the responder 404 may record the ToD time t_{1,2} corresponding to the ToD of the third FTM measurement frame 438.

In some aspects, the responder 404 may include angular information in the third FTM measurement frame 438. For example, the responder 404 may measure an AoA of the first ACK frame 436, and the responder 404 may include information indicating the measured AoA in the third FTM measurement frame 438.

The initiator 402 may receive the third FTM measurement frame 438 and respond with a second ACK frame 440 that may include at least one TRN field. The initiator 402 may calculate an RTT corresponding to the exchange of frames 434, 436. For example, the initiator may calculate a first RTT as (t_{4,1}−t_{1,1})−(t_{3,1}−t_{2,1}). The first RTT may have a timing resolution of picoseconds and/or nanoseconds, although other timing resolutions are possible. Using the estimated first RTT, the initiator 402 may be estimate a position of the initiator 402. For example, given the position of the responder 404, the initiator 402 may estimate a position of the initiator 402.

In various aspects, initiator 402 may obtain information indicating the position of the responder 404 based on information included in one of the frames 426, 434, 438 (e.g., in a data field) or information obtained in another frame (e.g., a frame received by the initiator during beamforming training or before the FTM session). In one aspect, the initiator 402 may estimate a position of the initiator 402 further based on angular information associated with one or more frames, such as the AoA included in the third FTM measurement frame 438.

In some aspects, the initiator 402 may provide the times t_{1,1}, t_{2,1}, t_{3,1}, t_{4,1}, and/or the angular information to a server (e.g., a location server). The location server may calculate the first RTT for the initiator 402 and provide the first RTT to the initiator, for example, in order to reduce processing load on the initiator 402.

In various aspects, the initiator 402 and responder 404 may continue the FTM session, e.g., until the initiator 402 terminates the FTM session or until a time or number of FTM bursts specified in the negotiated parameters is satisfied. For example, the responder 404 may record the ToA time t_{4,2} corresponding to reception of the second ACK frame 440. The responder 404 may transmit the fourth FTM measurement frame 442 indicating ToD time t_{1,2} of the third FTM measurement frame 438 and the ToA time t_{4,2} of the second ACK frame 440. Using the ToD time t_{1,2} of the third FTM measurement frame 438, the ToA time t_{4,2} of the second ACK frame 440, the ToA time t_{2,2} of the third FTM measurement frame 438, and the ToD time t_{3,2} of the second ACK frame 440, the initiator 402 may calculate a second RTT.

The initiator 402 may record the ToA time t_{2,3} of the fourth FTM measurement frame 442 and respond to the fourth FTM measurement frame 442 with a third ACK frame 444 (including at least one TRN field). The initiator 402 may record the ToD time t_{3,3} of the third ACK frame 444. The responder 404 may transmit, to the initiator 402, a fifth FTM measurement frame 446 that includes the ToD time t_{1,3} of the fourth FTM measurement frame 442 and the ToA time t_{4,3} of third ACK frame 444. In some aspects, the responder 404 may include, in the fifth FTM measurement frame 446, angular information, such as the AoA of the third ACK frame 444.

The initiator 402 may calculate a third RTT based on the ToD time t_{1,3} of the fourth FTM measurement frame 442, the ToA time t_{4,3} of the third ACK frame 444, the ToA time t_{2,3} of the fourth FTM measurement frame 442, and the ToD time t_{3,3} of the third ACK frame 444.

Responsive to the fifth FTM measurement frame 446, the initiator 402 may transmit an ACK message 448, which may conclude the FTM session. In one aspect, the initiator 402 may transmit another FTM request frame with a trigger field set to “0” in order to conclude the FTM session. If the initiator 402 performs a subsequent FTM session, the initiator 402 may again perform one or more of the aforementioned operations, for example, beginning with an initial FTM request in order to negotiate parameters for the subsequent FTM session.

### Example Positioning Estimation Based on FTM Protocol

As described, supra, the FTM protocol may provide an approach to position determination that may be relatively more accurate than existing approaches. However, the position determination by the wireless apparatus may be affected by the path used for the frame exchange according to the FTM protocol. Consequently, the position determination may be adversely affected when the frame exchange occurs on a reflected path, for example, instead of a line of sight (LoS) path between the wireless apparatus and the remote apparatus. In order to address this issue, the present disclosure may describe an approach in which the wireless apparatus uses, for at least a portion of an FTM session (e.g., the measurement portion), a first path (e.g., LoS path) that is relatively more direct than a second path even though the second path may offer relatively better channel conditions than the first path.

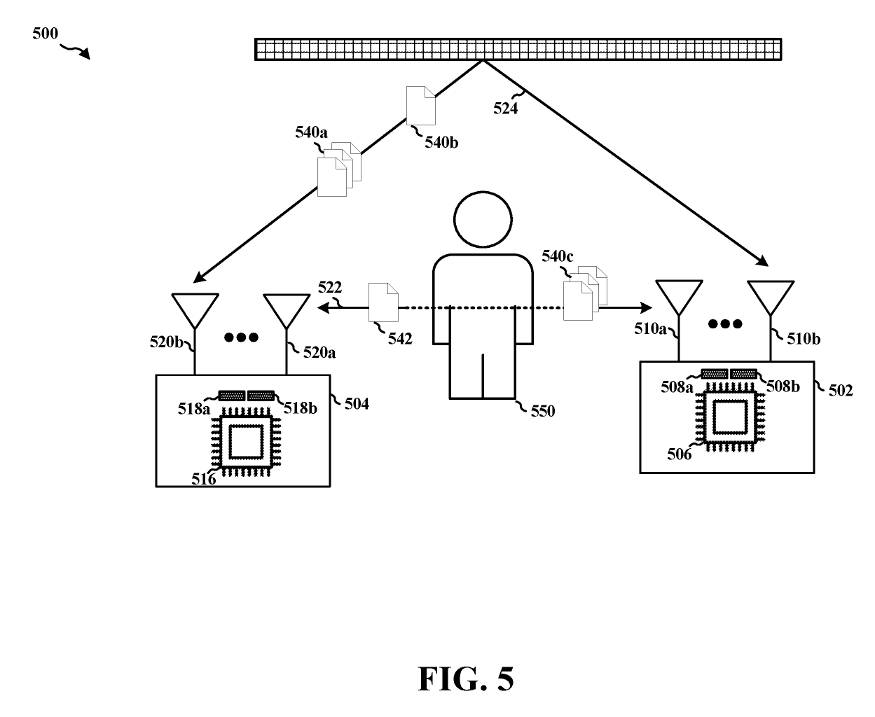

FIG. 5 shows an example block diagram of a wireless communications system 500. The wireless communications system 500 may include an initiator 502 (e.g., an aspect of a UT 120, an aspect of the initiator 402, etc.) and a responder 504 (e.g., an aspect of a UT 120, an aspect of an AP 110, an aspect of the responder 404, etc.). The initiator 502 may include a processing system 506 configured to communicate with the antenna element(s) through a first interface 508a and/or a second interface 508b. Each of the first interface 508a and/or the second interface 508b may be implemented in hardware, software, or a combination. For example, at least one of the first interface 508a and/or the second interface 508b may include a bus (e.g., a bus system connected with the processing system 506) and/or an interface to the processing system 506. In an aspect, the first interface 508a and the second interface 508b may be a same interface. In an aspect, the initiator 502 may control the antenna element(s) via different initiator sets of antenna settings 510a-b (e.g., antenna weight vectors). Initiator sets of antenna settings 510a-b may differently control inputs (e.g., for transmission) and/or outputs (e.g., for reception) of antenna element(s) and/or transmit/receive chains corresponding to antenna element(s). For example, initiator sets of antenna settings 510a-b may differently weight input signals to and/or output signals from antenna element(s) (and/or transmit/receive chains) when the initiator 502 applies input signals to be transmitted and/or combines output signals that are received.

The responder 504 may include a processing system 516 configured to communicate with the antenna element(s) through a first interface 518a and/or a second interface 518b. Each of the first interface 518a and/or the second interface 518b may be implemented in hardware, software, or a combination. For example, at least one of the first interface 518a and/or the second interface 518b may include a bus (e.g., a bus system connected with the processing system 516) and/or an interface to the processing system 516. In an aspect, the first interface 518a and the second interface 518b may be a same interface. In an aspect, the responder 504 may control the antenna element(s) via different responder sets of antennas settings 520a-b (e.g., antenna weight vectors). Responder sets of antenna settings 520a-b may differently control inputs (e.g., for transmission) and/or outputs (e.g., for reception) of antenna element(s) and/or transmit/receive chains corresponding to antenna element(s). For example, responder sets of antenna settings 520a-b may differently weight input signals to and/or output signals from antenna element(s) (and/or transmit/receive chains) when the responder 504 applies input signals to be transmitted and/or combines output signals that are received.

The initiator 502 and the responder 504 may be configured for relatively high-frequency communication, such as millimeter wave (mmWave) communication in 60 GHz. Such relatively high-frequency communication may be based on beamforming, e.g., using phased arrays at both sides for achieving a satisfactory link. In order to achieve a satisfactory link the initiator 502 and the responder 504 may perform beamforming training. For beamforming training, the initiator 502 and the responder 504 may exchange one or more training signals in order to respectively determine (e.g., identify) one or more sets of antenna settings (e.g., antenna weight vectors, phasings, etc.) for one or more paths over which the initiator 502 and the responder 504 may communicate. For example, the initiator 502 and the responder 504 may each perform a sector sweep following by a beam refining phase. During the sector sweep, each transmission may be sent using a different sector (e.g., covering a directional beam of a certain width) identified in a frame of the sector sweep, which may provide sufficient signaling to allow both the initiator 502 and the responder 504 to determine one or more sets of antenna settings for both transmission and reception.

Due to the high frequency and directional nature of beamforming, paths between the initiator 502 and the responder 504 may be susceptible to interference (e.g., blockers) that attenuate signals. However, paths between the initiator 502 and the responder 504 may be realized by way of reflected signals. For example, even when a LoS path between the initiator 502 and the responder 504 is attenuated due to a blocker, the initiator 502 and the responder 504 may still achieve a satisfactory link over a path that is reflected (e.g., around the blocker).

In the illustrated aspect, the initiator 502 and the responder 504 may perform beamforming training to identify at least two paths 522, 524 between the initiator 502 and the responder 504. For example, the initiator 502 and the responder 504 may identify a first path 522. At the initiator 502, the first path 522 may correspond to an initiator first set of antenna settings 510a for the initiator 502. At the responder 504, the first path 522 may correspond to the responder first set of antenna settings 520a. In an aspect, the first path may be an LoS path. In other aspects, the first path may be a reflected path.

Similarly, the initiator 502 and the responder 504 may identify a second path 524. At the initiator 502, the second path 524 may correspond to an initiator second set of antenna settings 510b for the initiator 502. At the responder 504, the second path 524 may correspond to the responder second set of antenna settings 520b. In an aspect, the second path 524 may be a reflected path.

In aspects, the first path 522 may be obstructed by a blocker 550, such as a person, an object, and the like. The blocker 550 may cause signal attenuation on the first path 522. Although reflected, the second path 524 may offer better channel conditions (e.g., higher SNR, lower attenuation, etc.) than the first path 522. Accordingly, the initiator 502 and the responder 504 may select the second path 524 for communication. However, the second path 524 may have a relatively longer distance than the first path 522.

Due to the difference between the first path 522 and the second path 524, an FTM session may be less accurate when frames are exchanged over the second path 524 than when frames are exchanged over the first path 522. Thus, the initiator 502 may prefer the first path 522 for an FTM session instead of the second path 524. While signal communication over the first path 522 may be attenuated due to the blocker 550, signal quality may still be sufficient for a measurement portion of an FTM session. Therefore, the processing system 506 of the initiator 502 may select the first path 522 for the measurement portion of an FTM session.

Because the initiator 502 and the responder 504 may be configured to use the second path 524 for communication (e.g., because the second path 524 provides better channel conditions than the first path 522), the initiator 502 may perform a negotiation portion 540a of an FTM session with the responder 504 using the second path 524. As described, supra, the negotiation portion 540a may include, for example, the initial FTM request frame 422, the ACK message 424, the first FTM measurement frame 426, and/or the ACK message 428.

After the negotiation portion 540a of the FTM session, the initiator 502 may indicate, to the responder 504, that the measurement portion 540c of the FTM session is to occur over the first path 522. In various aspects, the processing system 506 of the initiator 502 may generate an FTM request frame 540b that includes a trigger field. The processing system 506 of the initiator 502 may set the trigger field to a value indicating that the measurement portion 540c of the FTM session is to occur over the first path instead of the second path. In various aspects, the value indicating that the measurement portion 540c of the FTM session is to occur over the first path instead of the second path may be predefined. For example, the value may be predefined to correspond to a path having a shortest distance. The first interface 508a of the initiator 502 may output the FTM request frame 540b for transmission to the responder 504, for example, using the initiator second set of antenna settings 510b corresponding to the second path 524.

In connection with the indication to use the first path 522, the processing system 506 of the initiator 502 may select the initiator first set of antenna settings 510a. In one aspect, the processing system 506 of the initiator 502 may switch to the initiator first set of antenna settings 510a after receiving an ACK message from the responder 504 (e.g., the ACK message 432), which may indicate that the responder 504 acknowledges the switch to the first path 522 for the measurement portion 540c of the FTM session.

The first interface 518a of the responder 504 may be configured to obtain the FTM request frame 540b over the second path 524 using the responder second set of antenna settings 520b. The processing system 516 of the responder 504 may be configured to select the responder first set of antenna settings 520a for the measurement portion 540c of the FTM session based on the value of the trigger field in the FTM request frame 540b.

The processing system 516 of the responder 504 may generate a second FTM measurement frame (e.g., the second FTM measurement frame 434) of the measurement portion 540c. As described, supra, the second FTM measurement frame may include a ToA and/or ToD (e.g., set to zero). The processing system 516 of the responder 504 may include, in the second FTM measurement frame, at least one TRN field. The processing system 516 may record the ToD time t_{1,1} of the second FTM measurement frame. The second interface 518b of the responder 504 may output the second FTM measurement frame for transmission to the initiator 502 over the first path 522 using the responder first set of antenna settings 520a.

The second interface 508b of the initiator 502 may be configured to obtain the second FTM measurement frame of the measurement portion 540c of the FTM session. The processing system 506 of the initiator 502 may be configured to record the ToA time t_{2,1} of the second FTM measurement frame (e.g., using the at least one TRN field of the second FTM measurement frame).

Continuing with the measurement portion 540c of the FTM session using the first path 522, the processing system 506 of the initiator 502 may be configured to generate a first ACK frame (e.g., the first ACK frame 436), which may include at least one TRN field. The first interface 508a of the initiator 502 may be configured to output the first ACK frame for transmission to the responder 504 over the first path 522 using the initiator first set of antenna settings 510a. The processing system 506 of the initiator 502 may record the ToD time t_{3,1} of the first ACK frame.

The first interface 518a of the responder 504 may be configured to obtain the first ACK frame over the first path 522 using the responder first set of antenna settings 520a. The processing system 516 of the responder 504 may record the ToA time t_{4,1} of the first ACK frame. In an aspect, the processing system 516 of the responder 504 may measure the AoA of the first ACK frame. In an aspect, this exchange of the second FTM frame and the first ACK frame may comprise at least a portion of a first FTM burst.

The processing system 516 of the responder 504 may be configured to generate a third FTM measurement frame (e.g., the third FTM measurement frame 438) of the measurement portion 540c of the FTM session. The processing system 516 of the responder 504 may include, in the third FTM measurement frame, information indicating the ToD time t_{1,1} and the ToA time t_{4,1}. In one aspect, the processing system 516 of the responder 504 may include the measured AoA in the third FTM measurement frame.

The second interface 518b of the responder 504 may output the third FTM measurement frame for transmission to the initiator 502 over the first path 522 using the responder first set of antenna settings 520a. In some aspects, the processing system 516 of the responder 504 may record a ToD time t_{1,2} for a next FTM burst.

The second interface 508b of the initiator 502 may obtain the third FTM measurement frame over the first path 522 using the initiator first set of antenna settings 510a. The processing system 506 of the initiator 502 may detect the ToD time t_{1,1} and the ToA time t_{4,1} indicated in the third FTM measurement frame.

Based on ToD time t_{1,1}, ToA time t_{2,1}, ToD time t_{3,1}, and the ToA time t_{4,1}, the processing system 506 of the initiator 502 may be configured to determine a position of the initiator 502. For example, the processing system 506 of the initiator 502 may be configured to estimate an RTT based on the difference of (t_{4,1,}−t_{1,1})−(t_{3,1}−t_{2,1}). In some aspects, the processing system 506 of the initiator 502 may be configured to determine a position of the initiator 502 based on the AoA indicated in the third FTM measurement frame.

In aspects, the determined position of the initiator 502 may be used for any number of different purposes. For example, the determined position may be provided to a higher layer (e.g., application layer). In another example, the determined position may be transmitted to a server (e.g., location server).

As described, supra, the measurement portion 540c of the FTM session may include additional FTM bursts for which the processing system 506 of the initiator 502 may estimate or refine RTT measurements. Correspondingly, the processing system 506 of the initiator 502 may determine (e.g., estimate or refine) the position of the initiator 502 based on the additional FTM bursts.

When the measurement portion 540c of the FTM session concludes, the initiator 502 may indicate to the responder 504 that communication should resume on the second path 524 (e.g., in order to return to better channel conditions). In various aspects, the processing system 506 of the initiator 502 may generate a frame 542 that indicates, to the responder 504, that communication between the initiator 502 and the responder 504 should occur on the second path 524 after the measurement portion 540c of the FTM session. The first interface 508a of the initiator 502 may output the frame 542 for transmission to the responder 504, for example, over the first path using the initiator first set of antenna settings 510a. In aspects, the processing system 506 of the initiator 502 may select the initiator second set of antenna settings 510b after the frame 542 is output for transmission to the responder 504.

The first interface 518a of the responder 504 may be configured to obtain the frame 542 over the first path 522 using the responder first set of antenna settings 520a. Based on the frame 542, the processing system 516 of the responder 504 may be configured select the responder second set of antenna settings 520b for communication with the initiator 502 over the second path 524.

In one aspect, the frame 542 may be a contention-free (CF) end frame. The CF end frame may indicate that the frame exchange has concluded and communication should resume on the second path 524. In some aspects, the processing system 516 of the responder 504 may generate a second CF end frame responsive to the received CF end frame, and the second interface 518b may be configured to output the second CF end frame for transmission to the initiator 502.

In another aspect, the frame 542 may be an FTM request frame having a trigger field. The processing system 506 of the initiator 502 may set the trigger field to a value indicating that the measurement portion 540c of the FTM session has concluded and communication should resume on the second path 524. The processing system 516 of the responder 504 may be configured to generate an ACK message responsive to the final FTM request frame, and the second interface 518b may be configured to output the ACK message for transmission to the initiator 502.

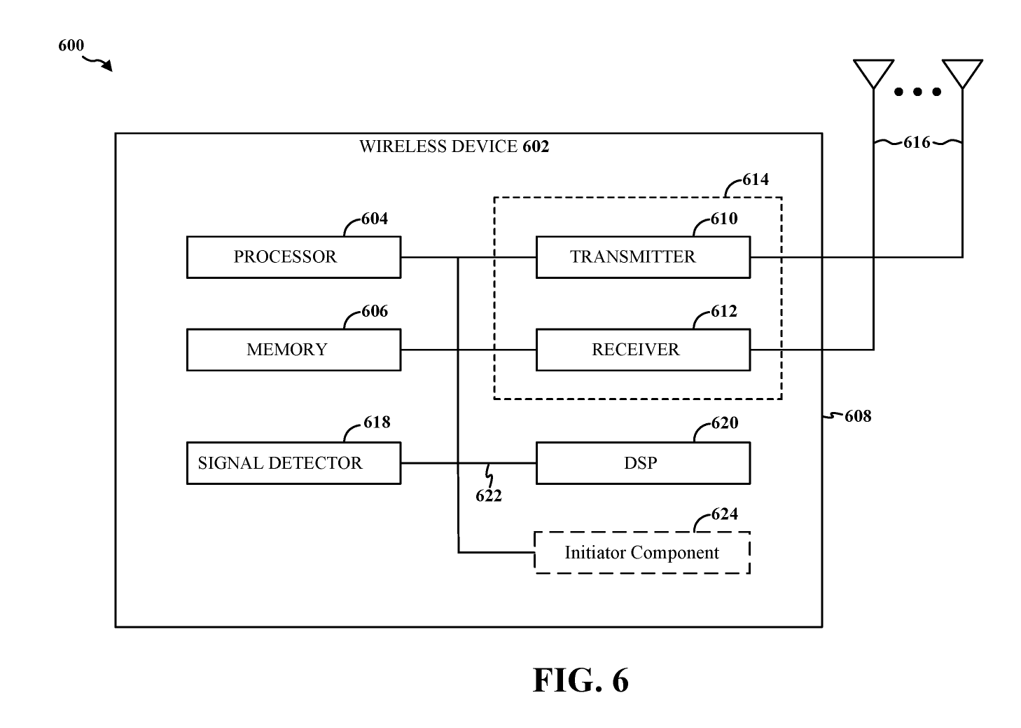

FIG. 6 shows an example functional block diagram of a wireless device 602 configured for communication according to an FTM protocol. The wireless device 602 may be an initiator of an FTM session. The wireless device 602 is an example of a device that may be configured to implement the various methods described herein. For example, the wireless device 602 may be the AP 110, the UT 120, the initiator 402, and/or the initiator 502.

The wireless device 602 may include a processor 604 which controls operation of the wireless device 602. The processor 604 may also be referred to as a central processing unit (CPU). Memory 606, which may include both read-only memory (ROM) and random access memory (RAM), may provide instructions and data to the processor 604. A portion of the memory 606 may also include non-volatile random access memory (NVRAM). The processor 604 typically performs logical and arithmetic operations based on program instructions stored within the memory 606. The instructions in the memory 606 may be executable (by the processor 604, for example) to implement the methods described herein.

The wireless device 602 may also include a housing 608, and the wireless device 602 may include a transmitter 610 and a receiver 612 to allow transmission and reception of data between the wireless device 602 and a remote device. The transmitter 610 and receiver 612 may be combined into a transceiver 614. A single transmit antenna or a plurality of transmit antennas 616 may be attached to the housing 608 and electrically coupled to the transceiver 614. The wireless device 602 may also include multiple transmitters, multiple receivers, and multiple transceivers.

The wireless device 602 may also include a signal detector 618 that may be used in an effort to detect and quantify the level of signals received by the transceiver 614 or the receiver 612. The signal detector 618 may detect such signals as total energy, energy per subcarrier per symbol, power spectral density and other signals. The wireless device 602 may also include a digital signal processor (DSP) 620 for use in processing signals. The DSP 620 may be configured to generate a packet for transmission. In some aspects, the packet may comprise a physical layer convergence procedure (PLCP) protocol data unit (PPDU).

The various components of the wireless device 602 may be coupled together by a bus system 622, which may include a power bus, a control signal bus, and a status signal bus in addition to a data bus.

In one configuration, when the wireless device 602 is implemented as an initiator of an FTM session according to an FTM protocol, the wireless device 602 may include an initiator component 624. The initiator component 624 may identify a first set of antenna settings and a second set of antenna settings based on beamforming training with a second apparatus. In aspects, the first set of antenna settings may correspond to a first path with the second apparatus different from than a second path with the second apparatus corresponding to the second set of antenna settings. The initiator component 624 may generate a first frame including an indication to use the first path instead of the second path for at least a portion of an FTM session. The initiator component 624 may output the first frame for transmission to the second apparatus. The initiator component 624 may obtain, from the second apparatus based on the first set of antenna settings, a plurality of FTM measurement frames associated with the at least the portion of the FTM session. In an aspect, the first frame comprises a trigger field associated with the FTM session, and the indication to use the first path instead of the second path comprises a value of the trigger field. The initiator component 624 may further generate a second frame including acknowledgement information associated with a first FTM measurement frame of the plurality of FTM measurement frames and including one or more TRN fields, and the initiator component 624 may output the second frame for transmission to the second apparatus using the first set of antenna settings. In an aspect, a second FTM measurement frame of the plurality of FTM measurement frames indicates at least one of a time of arrival associated with the second frame or a time of departure associated with the first FTM measurement frame, and the initiator component 624 may further determine a position of the wireless device 602 based at least partially on the at least one of the time of arrival or the time of departure. In an aspect, the second FTM measurement frame indicates at least one of an angle of arrival associated with the second frame or an angle of departure associated with the second FTM measurement frame, and the initiator component 624 may further determine the position of the wireless device 602 based at least partially on the at least one of the angle of arrival or the angle of departure. The initiator component 624 may further generate a third frame including an indication to use the second path instead of the first path after the FTM session, and output the third frame for transmission to the second apparatus. In an aspect, the third frame comprises a CF end frame or an FTM request frame indicating termination of the FTM session.

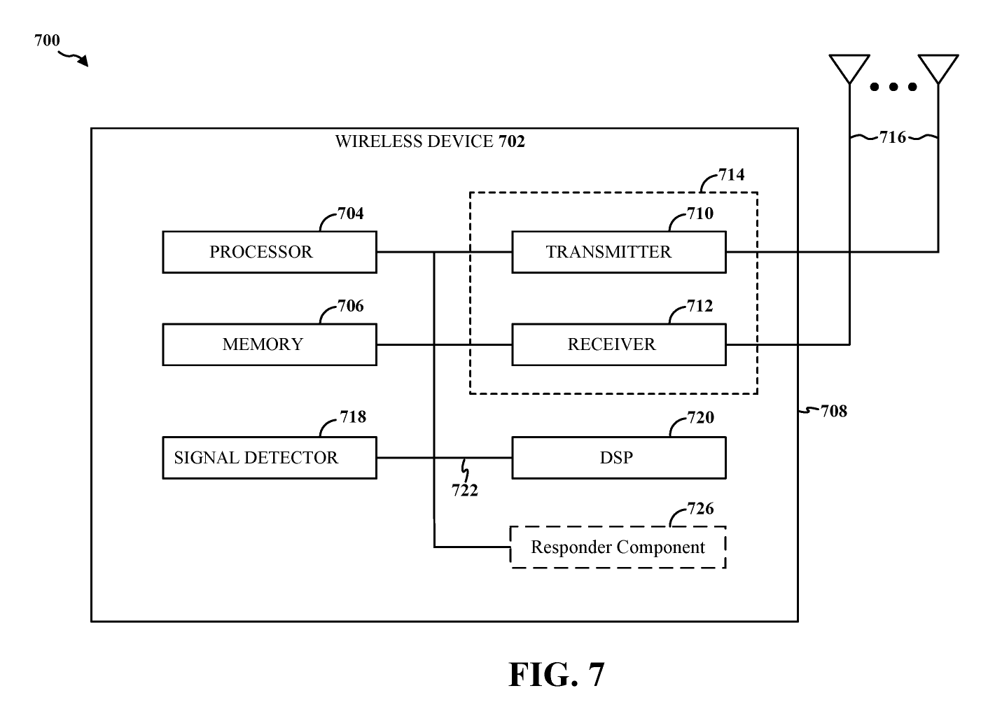

FIG. 7 shows an example functional block diagram of a wireless device 702 configured for communication according to an FTM protocol. The wireless device 702 may be a responder of an FTM session. The wireless device 702 is an example of a device that may be configured to implement the various methods described herein. For example, the wireless device 702 may be the AP 110, the UT 120, the responder 404, and/or the responder 504.

The wireless device 702 may include a processor 704 which controls operation of the wireless device 702. The processor 704 may also be referred to as a central processing unit (CPU). Memory 706, which may include both read-only memory (ROM) and random access memory (RAM), may provide instructions and data to the processor 704. A portion of the memory 706 may also include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The wireless device 702 may also include a housing 708, and the wireless device 702 may include a transmitter 710 and a receiver 712 to allow transmission and reception of data between the wireless device 702 and a remote device. The transmitter 710 and receiver 712 may be combined into a transceiver 714. A single transmit antenna or a plurality of transmit antennas 716 may be attached to the housing 708 and electrically coupled to the transceiver 714. The wireless device 702 may also include multiple transmitters, multiple receivers, and multiple transceivers.

The wireless device 702 may also include a signal detector 718 that may be used in an effort to detect and quantify the level of signals received by the transceiver 714 or the receiver 712. The signal detector 718 may detect such signals as total energy, energy per subcarrier per symbol, power spectral density and other signals. The wireless device 702 may also include a digital signal processor (DSP) 720 for use in processing signals. The DSP 720 may be configured to generate a packet for transmission. In some aspects, the packet may comprise a physical layer convergence procedure (PLCP) protocol data unit (PPDU).

The various components of the wireless device 702 may be coupled together by a bus system 722, which may include a power bus, a control signal bus, and a status signal bus in addition to a data bus.

In one configuration, when the wireless device 702 is implemented as a responder of an FTM session according to an FTM protocol, the wireless device 702 may include a responder component 724. The responder component 724 may obtain a first frame including an indication to use a first path with a second apparatus for at least a portion of an FTM session, the first path having a relatively lower channel quality but relatively shorter distance than a second path with the second apparatus. The responder component 724 may identify, based on beamforming training with the second apparatus, a first set of antenna settings corresponding to the first path with the second apparatus and a second set of antenna settings corresponding to the second path with the second apparatus. The responder component 724 may select, based on the indication to use the first path, the first set of antenna settings instead of the second set of antenna settings. The responder component 724 may generate a plurality of FTM measurement frames associated with the FTM session. The responder component 724 may output each FTM measurement frame of the plurality of FTM measurement frames for transmission using the first set of antenna settings. In an aspect, the first frame comprises a trigger field associated with the FTM session, the indication to use the first path instead of the second path comprises a value of the trigger field, and the selection of the first set of antenna settings instead of the second set of antenna settings is based on the value of the trigger field. In an aspect, the responder component 724 may further obtain, from the second apparatus using the first set of antenna settings, a second frame including acknowledgement information associated with a first FTM measurement frame of the plurality of FTM measurement frames and including one or TRN fields, and the generation of the plurality of FTM measurement frames comprises generating a second FTM measurement frame that indicates at least one of a time of arrival associated with the second frame or a time of departure associated with the first FTM measurement frame. In an aspect, the second FTM measurement frame indicates at least one of an angle of arrival associated with the second frame or an angle of departure associated with the second FTM measurement frame. In an aspect, the responder component 724 may further obtain a third frame including an indication to use the second path instead of the first path after the FTM session, and select, based on the indication to use the second path, the second set of antenna settings for communication with the second apparatus after the FTM session. In an aspect, the third frame comprises a CF end frame or an FTM request frame indicating termination of the FTM session.

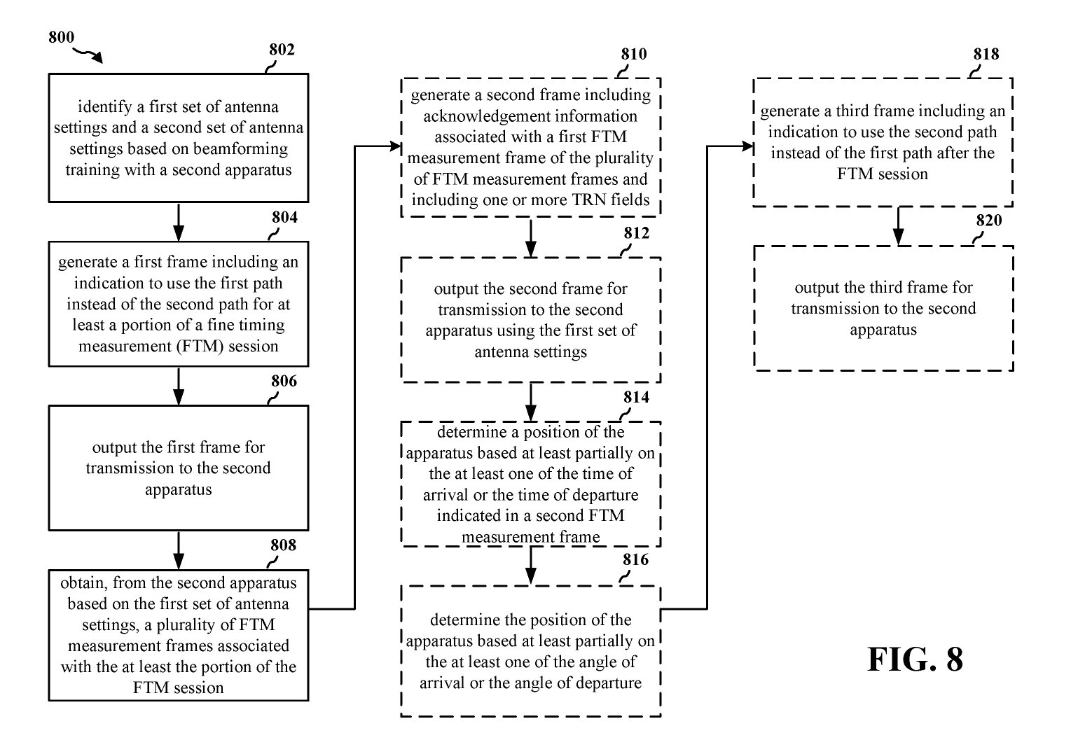

FIG. 8 is a flowchart of an example method 800 of initiating an FTM session according to an FTM protocol, for example, in order to determine a position of an apparatus. The method 800 may be performed using an apparatus (e.g., a UT 120, the initiator 402, the initiator 502, the wireless device 602, and/or the initiator component 624). Although the method 800 is described below with respect to the elements of the initiator 402 and/or the initiator 502, other components may be used to implement one or more of the operations described herein. Blocks denoted by dotted lines may represent optional operations.

At block 802, an apparatus may identify a first set of antenna setting and a second set of antenna settings based on beamforming training with a second apparatus. In various aspects, the first set of antenna settings may correspond to a first path with the second apparatus having a relatively lower channel quality but relatively shorter distance than a second path with the second apparatus corresponding to the second set of antenna settings. For example, referring to FIG. 5, the processing system 506 of the initiator 502 may identify the initiator first set of antenna settings 510a and the initiator second set of antenna settings 510b based on beamforming training with the responder 504. In an aspect, the initiator first set of antenna settings 510a may correspond to the first path 522 with the responder 504 having a relatively lower channel quality but relatively shorter distance than the second path 524 with the responder 504 corresponding to the initiator second set of antenna settings 510b.

At block 804, the apparatus may generate a first frame including an indication to use the first path instead of the second path for at least a portion of an FTM session. In an aspect, the first frame comprises a trigger field associated with the FTM session, and the indication to use the first path instead of the second path comprises a value of the trigger field. For example, referring to FIG. 4, the initiator 402 may generate the FTM request frame 430, including a trigger field having a value set to indicate to use a first path for at least a portion of the FTM session instead of a second path. For example, referring to FIG. 5, the processing system 506 of the initiator 502 may generate the FTM request frame 540b that indicates the first path 522 is to be used instead of the second path 524 for the measurement portion 540c of the FTM session.

At block 806, the apparatus may output the first frame for transmission to the second apparatus. For example, referring to FIG. 4, the initiator 402 may output the FTM request frame 430 for transmission to the responder 404. For example, referring to FIG. 5, the first interface 508a of the initiator 502 may output the FTM request frame 540b for transmission to the responder 504, e.g., over the second path 524 using the initiator second set of antenna settings 510b.

At block 808, the apparatus may obtain, from the second apparatus based on the first set of antenna settings, a plurality of FTM measurements frames associated with the at least the portion of the FTM session. In one aspect, the plurality of FTM measurement frames may include a first FTM measurement frame. For example, referring to FIG. 4, the initiator 402 may obtain at least one of the second FTM measurement frame 434, the third FTM measurement frame 438, the fourth FTM measurement frame 442, and/or the fifth FTM measurement frame 446. For example, referring to FIG. 5, the second interface 508b of the initiator 502 may be configured to obtain, from the responder 504 based on the initiator first set of antenna settings 510a, a plurality of FTM measurement frames of the measurement portion 540c of the FTM session.

At block 810, the apparatus may generate a second frame including acknowledgement information associated with a first FTM measurement frame of the plurality of FTM measurement frames and including one or more TRN fields. For example, referring to FIG. 4, the initiator 402 may generate the first ACK frame 436 that includes the at least one TRN field. The first ACK frame 436 may include acknowledgement information associated with the second FTM measurement frame 434. For example, referring to FIG. 5, the processing system 506 of the initiator 502 may be configured to generate a first ACK frame of the measurement portion 540c of the FTM session that includes acknowledgement information associated with a second FTM measurement frame of the measurement portion 540c of the FTM session and that includes at least one TRN field.

At block 812, the apparatus may output the second frame for transmission to the second apparatus using the first set of antenna settings. For example, referring to FIG. 4, the initiator 402 may output the first ACK frame 436 for transmission to the responder 404 using a first set of antenna settings. For example, referring to FIG. 5, the second interface 508b of the initiator 502 may output an ACK frame of the measurement portion 540c of the FTM session for transmission to the responder 504 using the initiator first set of antenna settings 510a.

At block 814, the apparatus may determine a position of the apparatus based at least partially on at least one of a time of arrival or a time of departure indicated in a second FTM measurement frame of the plurality of FTM measurement frames. In an aspect, a second FTM measurement frame of the plurality of FTM measurement frames indicates at least one of a ToA t₄ associated with the second frame or a ToD t₁ of the first FTM measurement frame. In an aspect, the apparatus may have recorded a ToA t₂ associated with the first FTM measurement frame and a ToD t₃ associated with the second frame. The apparatus may estimate an RTT based on t₁, t₂, t₃, and t₄. The apparatus may use the estimated RTT to determine a position of the apparatus.

For example, referring to FIG. 4, the initiator 402 may determine a position of initiator 402 based at least partially on at least one of a ToA t_{4,1} of the first ACK frame 436 or a ToD t_{1,1} of the second FTM measurement frame 434. For example, the initiator 402 may record a ToA t_{2,1} of the second FTM measurement frame 434 and a ToD t_{3,1} of the first ACK frame 436. The initiator 402 may estimate an RTT based on t_{1,1}, t_{2,1}, t_{3,1}, and t_{4,1}.

For example, referring to FIG. 5, the processing system 506 of the initiator 502 may determine a position of the initiator 502 based at least partially on a ToD t₁ of the second FTM measurement frame, a ToA t₂ associated with the second FTM measurement frame, a ToD t₃ associated with the first ACK frame, and a ToA t₄ associated with the first ACK frame of the measurement portion 540c of the FTM session. As described, supra, t₁ and t₄ may be received in a third FTM measurement frame, and t₂ and t₃ may be recorded by the processing system 506 of the initiator 502. The processing system 506 of the initiator 502 may estimate an RTT as the difference (t₄−t₁)−(t₃−t₂). The processing system 506 of the initiator 502 may determine the position of the initiator 502 based at least partially on the estimated RTT.

At block 816, the apparatus may determine the position of the apparatus further based at least partially on at least one of an angle of arrival or an angle of departure. For example, the second FTM measurement frame of the obtained plurality of FTM measurement frames may indicate an AoA of the second frame and/or an AoD of the first or second FTM measurement frame. The apparatus may further determine a position of the apparatus based on the indicated AoA and/or AoD.

For example, referring to FIG. 4, the initiator 402 may obtain the third FTM measurement frame 438, which indicates the AoA of the first ACK frame 436. The initiator 402 may further determine a position of the initiator 402 based on the indicated AoA of the first ACK frame 436. For example, referring to FIG. 5, the second interface 508b of the initiator 502 may obtain a third FTM measurement frame indicating an AoA of the first ACK frame (responsive to the second FTM measurement frame). The processing system 506 of the initiator 502 may determine a position of the initiator 502 further based at least partially on the indicated AoA.

At block 818, the apparatus may generate a third frame including an indication to use the second path instead of the first path after the FTM session. In an aspect, the third frame comprises a CF end frame. In another aspect, the third frame comprises an FTM request frame indicating termination of the FTM session. For example, referring to FIG. 5, the processing system 506 of the initiator 502 may generate the frame 542 that includes an indication to use the second path 524 instead of the first path 522.

At block 820, the apparatus may output the third frame for transmission to the second apparatus. For example, referring to FIG. 5, the first interface 508a of the initiator 502 may output the frame 542 for transmission to the responder 504.

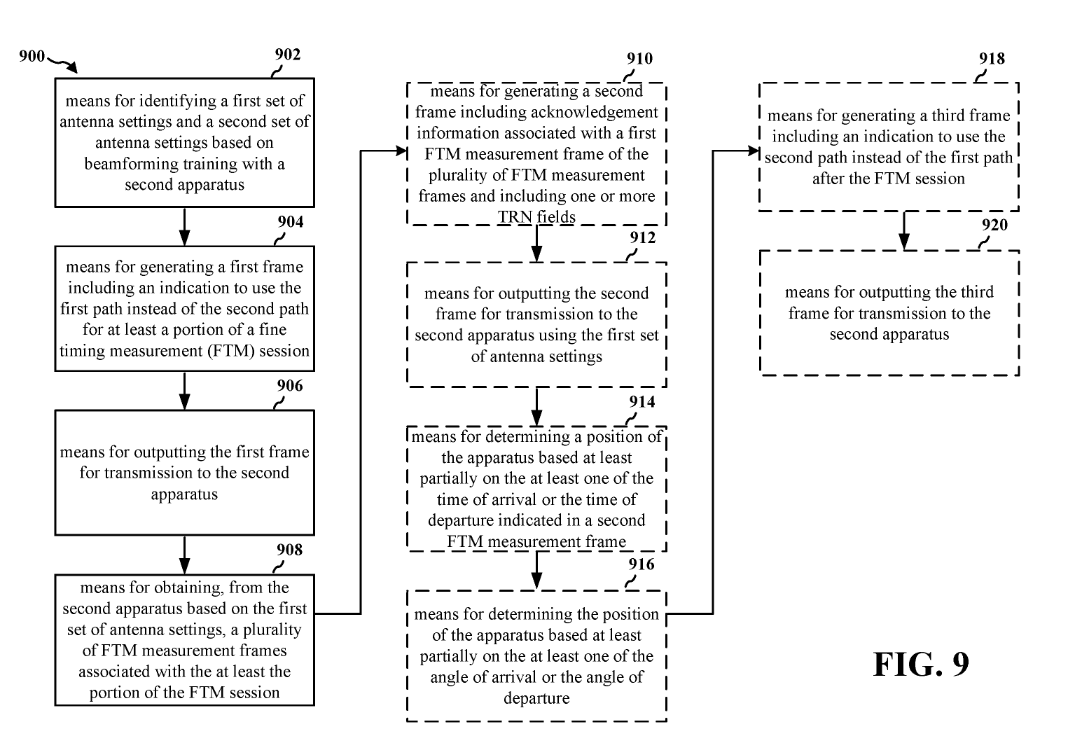

FIG. 9 illustrates exemplary means 900 capable of performing the operations set forth in FIG. 8. The exemplary means 900 may include means for identifying a first set of antenna settings and a second set of antenna settings based on beamforming training with a second apparatus 902. Means 902 may include, for example, controller 230, controllers 280, digital signal processor 620, and/or processor 604 shown in FIG. 2 and FIG. 6. Means 902 may include, for example, the processing system 506 shown in FIG. 5. The exemplary means 900 may include means for generating a first frame including an indication to use the first path instead of the second path for at least a portion of an FTM session 904. Means 904 may include, for example, controller 230, controllers 280, digital signal processor 620, and/or processor 604 shown in FIG. 2 and FIG. 6. Means 904 may include, for example, the processing system 506 shown in FIG. 5. The exemplary means 900 may include means for outputting the first frame for transmission to the second apparatus 906. Means 906 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 616, transmitter 610, digital signal processor 620, and/or processor 604 shown in FIG. 2 and FIG. 6. Means 906 may include, for example, the first interface 508a shown in FIG. 5. The exemplary means 900 may include means for obtaining, from the second apparatus based on the first set of antenna settings, a plurality of FTM measurement frames associated with the at least the portion of the FTM session 908. Means 908 may include, for example, an interface (e.g., of a processor), antennas 224, antennas 252, receiver units 222, receiver units 254, RX spatial processor 240, RX spatial processors 260, RX data processor 242, RX data processors 270, controller 230, controllers 280, antennas 616, receiver 612, digital signal processor 620, and/or processor 604 shown in FIG. 2 and FIG. 6. Means 908 may include, for example, the second interface 508b shown in FIG. 5. The exemplary means 900 may include means for generating a second frame including acknowledgement information associated with a first FTM measurement frame of the plurality of FTM measurement frames and including one or more TRN fields 910. Means 910 may include, for example, controller 230, controllers 280, digital signal processor 620, and/or processor 604 shown in FIG. 2 and FIG. 6. Means 910 may include, for example, the processing system 506 shown in FIG. 5. The exemplary means 900 may include means for outputting the second frame for transmission to the second apparatus using the first set of antenna settings 912. Means 912 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 616, transmitter 610, digital signal processor 620, and/or processor 604 shown in FIG. 2 and FIG. 6. Means 912 may include, for example, the first interface 508a shown in FIG. 5. The exemplary means 900 may include means for determining a position of the apparatus based at least partially on the at least one of the time of arrival or the time of departure indicated in a second FTM measurement frame 914. Means 914 may include, for example, controller 230, controllers 280, digital signal processor 620, and/or processor 604 shown in FIG. 2 and FIG. 6. Means 914 may include, for example, the processing system 506 shown in FIG. 5. The exemplary means 900 may include means for determining the position of the apparatus based at least partially on the at least one of the angle of arrival or the angle of departure 916. Means 916 may include, for example, controller 230, controllers 280, digital signal processor 620, and/or processor 604 shown in FIG. 2 and FIG. 6. Means 916 may include, for example, the processing system 506 shown in FIG. 5. The exemplary means 900 may include means for generating a third frame including an indication to use the second path instead of the first path after the FTM session 918. Means 918 may include, for example, controller 230, controllers 280, digital signal processor 620, and/or processor 604 shown in FIG. 2 and FIG. 6. Means 918 may include, for example, the processing system 506 shown in FIG. 5. The exemplary means 900 may include means for outputting the third frame for transmission to the second apparatus 920. Means 920 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 616, transmitter 610, digital signal processor 620, and/or processor 604 shown in FIG. 2 and FIG. 6. Means 920 may include, for example, the first interface 508a shown in FIG. 5. The exemplary means 900 may further include means for transmitting the first frame, which may include antennas 224, antennas 252, transmitter units 222, transmitter units 254, TX spatial processor 220, TX spatial processors 290, TX data processor 210, TX data processors 288, controller 230, controllers 280, antennas 616, transmitter 610, digital signal processor 620, and/or processor 604 shown in FIG. 2 and FIG. 6. The exemplary means 900 may further include means for receiving, based on the first set of antenna settings, the plurality of FTM measurement frames, which may include antennas 224, antennas 252, receiver units 222, receiver units 254, RX spatial processor 240, RX spatial processors 260, RX data processor 242, RX data processors 270, controller 230, controllers 280, antennas 616, receiver 612, digital signal processor 620, and/or processor 604 shown in FIG. 2 and FIG. 6.

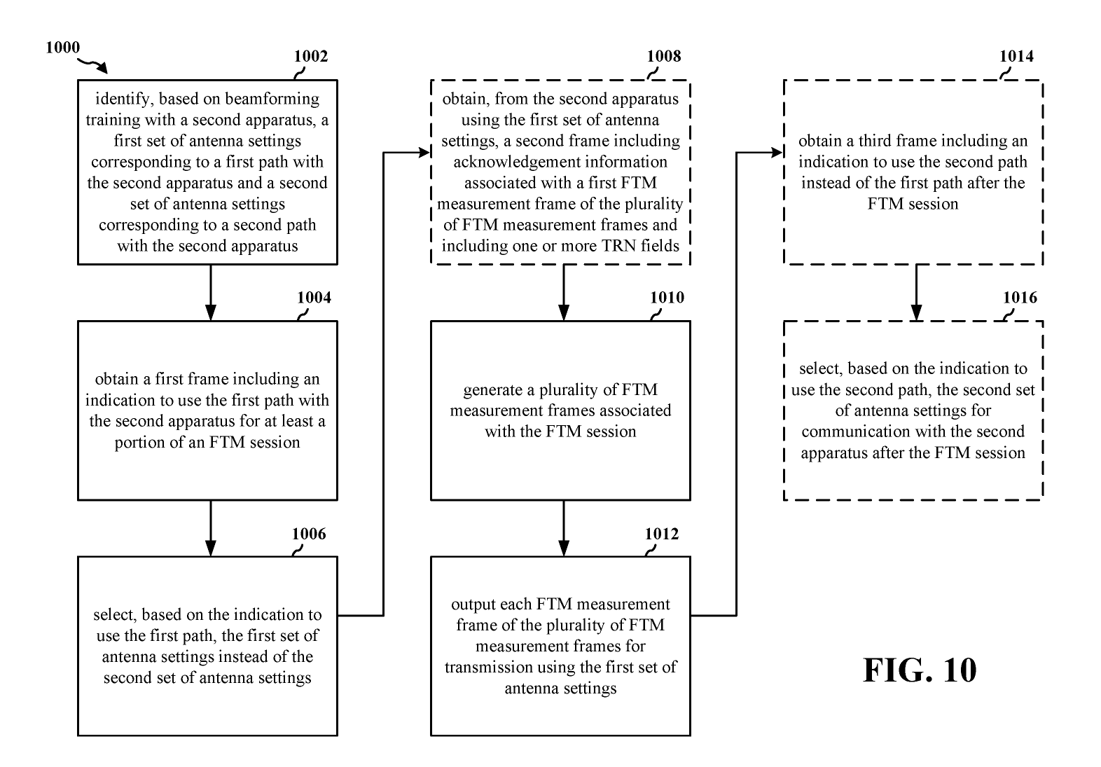

FIG. 10 is a flowchart of an example method 1000 of responding in an FTM session according to an FTM protocol, for example, in order to facilitate determination of a position by a second apparatus. The method 1000 may be performed using an apparatus (e.g., an AP 110, a UT 120, the responder 404, the responder 504, the wireless device 702, and/or the responder component 724). Although the method 1000 is described below with respect to the elements of the responder 404 and/or the responder 504, other components may be used to implement one or more of the operations described herein. Blocks denoted by dotted lines may represent optional operations.

At block 1002, the apparatus may identify, based on beamforming with a second apparatus, a first set of antenna settings corresponding to a first path with the second apparatus and a second set of antenna settings corresponding to a second path with the second apparatus. In aspects, the first path with the second apparatus may have a relatively lower channel quality but relatively shorter distance than the second path with the second apparatus. For example, referring to FIG. 5, the processing system 516 of the responder 504 may identify the responder first set of antenna settings 520a and the responder second set of antenna settings 520b based on beamforming training with the initiator 502. In an aspect, the responder first set of antenna settings 520a may correspond to the first path 522 with the initiator 502 having a relatively lower channel quality but relatively shorter distance than the second path 524 with the initiator 502 corresponding to the responder second set of antenna settings 520b.

At block 1004, the apparatus may obtain a first frame including an indication to use the first path with the second apparatus for at least a portion of an FTM session. In an aspect, the first frame comprises a trigger field associated with the FTM session, and the indication to use the first path instead of the second path comprises a value of the trigger field. For example, referring to FIG. 4, the responder 404 may receive the FTM request frame 430, including a trigger field having a value set to indicate to use a first path for at least a portion of the FTM session instead of a second path. For example, referring to FIG. 5, the first interface 518a of the responder 504 may obtain the FTM request frame 540b that indicates the first path 522 is to be used instead of the second path 524 for the measurement portion 540c of the FTM session.

At block 1006, the apparatus may select, based on the indication to use the first path, the first set of antenna settings instead of the second set of antenna settings. For example, referring to FIG. 5, the processing system 516 of the responder 504 may select the responder first set of antenna settings 520a instead of the responder second set of antenna settings 520b.

At block 1008, the apparatus may obtain, from the second apparatus using the first set of antenna settings, a second frame including acknowledgement information associated with a first FTM measurement frame of a plurality of FTM measurement frames and including one or more TRN fields. For example, the second frame may be an ACK frame responsive to a first FTM measurement frame transmitted by the apparatus. In an aspect, the apparatus may record a ToA t₄ associated with the second frame, where a ToD t₁ corresponds to the first FTM measurement frame. For example, referring to FIG. 4, the responder 404 may obtain, from the initiator 402, the first ACK frame 436 that includes the at least one TRN field. As illustrated, the first ACK frame 436 may be responsive to the second FTM measurement frame 434 transmitted by the responder 404. The responder 404 may record a ToA t_{4,1} associated with the first ACK frame 436, where a ToD t_{1,1} corresponds to the second FTM measurement frame 434. For example, referring to FIG. 5, the first interface 508a of the responder 504 may obtain, from the initiator 502, a first ACK frame of the measurement portion 540c of the FTM session. The processing system 516 of the responder 504 may record a ToA t₄ associated with the first ACK frame of the measurement portion 540c, where a ToD t₁ corresponds to a second FTM measurement frame of the measurement portion 540c.

At block 1010, the apparatus may generate a plurality of FTM measurement frames associated with the FTM session. In an aspect at least a portion of block 1010 may occur before block 1008. For example, the apparatus may generate the first FTM measurement frame, to which the second frame of block 1008 is responsive. After block 1008, the apparatus may generate a second FTM measurement frame that indicates a ToA t₄ associated with the second frame and a ToD t₁ that corresponds to the first FTM measurement frame to which the obtained second frame is responsive. In one aspect, the apparatus may include at least one of an AoA (e.g., an AoA of the obtained second frame) and/or an AoD (e.g., an AoD of the first FTM measurement frame, an AoD of the second FTM measurement frame).

For example, referring to FIG. 4, the responder 404 may generate the second FTM measurement frame 434. The responder 404 may receive the first ACK frame 436 in response to the second FTM measurement frame 434. Thereafter, the responder 404 may generate a third FTM measurement frame 438. The responder 404 may include, in the third FTM measurement frame 438, a ToD t_{1,1} that corresponds to the second FTM measurement frame 434 and a ToA t_{4,1} associated with the first ACK frame 436. For example, referring to FIG. 5, the processing system 516 of the responder 504 may generate a second FTM measurement frame (e.g., having ToA and ToD set to 0). After obtaining the first ACK frame in response to the second FTM frame, the processing system 516 of the responder 504 may generate a third FTM measurement frame that indicates a ToD t₁ corresponding to the second FTM measurement frame of the measurement portion 540c and indicates a ToA t₄ associated with the first ACK frame of the measurement portion 540c. In aspects, the processing system 516 of the responder 504 may measure an AoA of the first ACK frame and/or an AoD of the second or third FTM measurement frames. The processing system 516 may include the measured AoA and/or AoD in the third FTM measurement frame of the measurement portion 540c.

At block 1012, the apparatus may output the plurality of FTM measurement frames for transmission using the first set of antenna settings. In an aspect at least a portion of block 1012 may occur before block 1008. For example, the apparatus may generate (block 1010) and output (block 1012) the first FTM measurement frame, to which the second frame of block 1008 is responsive. After block 1008, the apparatus may generate (block 1010) and output (block 1012) a second FTM measurement frame that indicates a ToA t₄ associated with the second frame and a ToD t₁ that corresponds to the first FTM measurement frame to which the obtained second frame is responsive.

For example, referring to FIG. 4, the responder 404 may output the second FTM measurement frame 434 for transmission using a first set of antenna settings. The responder 404 may receive, using the first set of antenna settings, the first ACK frame 436 in response to the second FTM measurement frame 434. Thereafter, the responder 404 may output a third FTM measurement frame 438 for transmission to the initiator 402 using the first set of antenna settings. For example, referring to FIG. 5, the second interface 518b of the responder 504 may output a second FTM measurement frame (e.g., having ToA and ToD set to 0). After obtaining the first ACK frame in response to the second FTM frame, the second interface 518b of the responder 504 may output a third FTM measurement frame for transmission to the initiator 502 over the first path 522 using the responder first set of antenna settings 520a.

At operation 1014, the apparatus may obtain a third frame including an indication to use the second path instead of the first path after the FTM session. For example, the third frame may comprise a CF end frame or an FTM request frame indicating termination of the FTM session. For example, referring to FIG. 5, the first interface 518a of the responder 504 may obtain the frame 542 over the first path 522 using the responder first set of antenna settings 520a.

At operation 1016, the apparatus may select, based on the indication to use the second path, the second set of antenna settings for communication with the second apparatus after the FTM session. For example, referring to FIG. 5, the processing system 516 of the responder 504 may select the responder second set of antenna settings 520b for communication over the second path 524 when the FTM session is terminated.

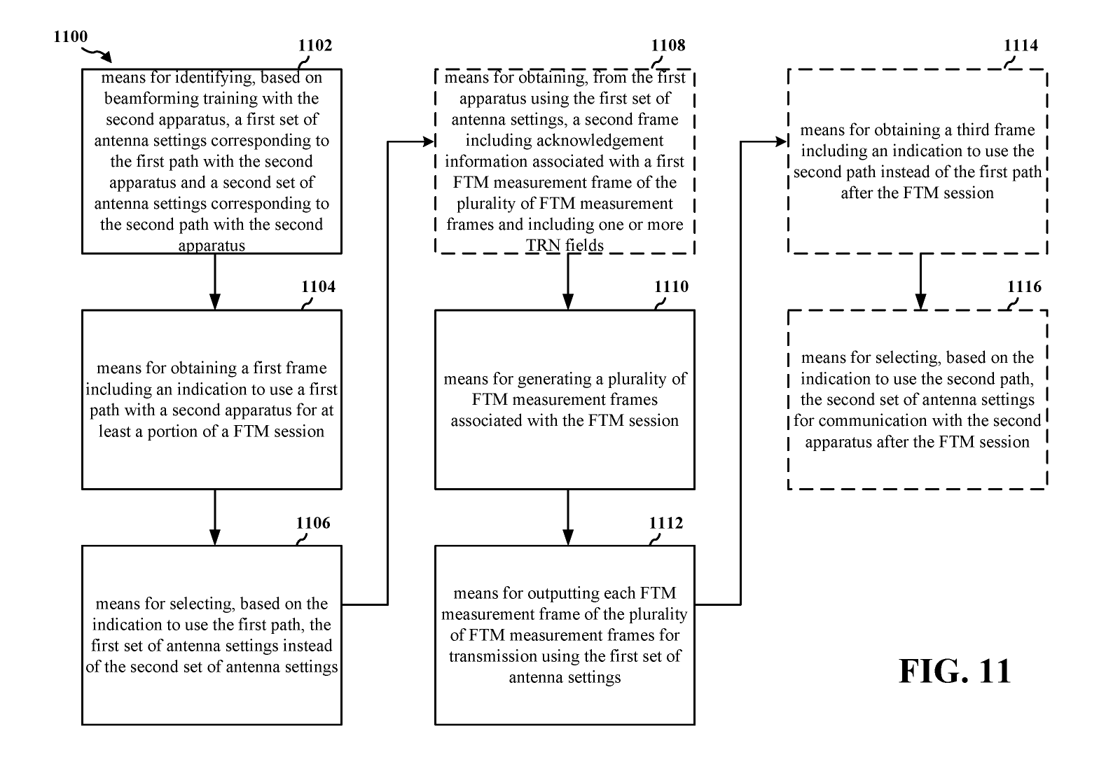

FIG. 11 illustrates exemplary means 1100 capable of performing the operations set forth in FIG. 10. The exemplary means 1100 may include means for identifying, based on beamforming training with the second apparatus, a first set of antenna settings corresponding to the first path with the second apparatus and a second set of antenna settings corresponding to the second path with the second apparatus 1102. Means 1102 may include, for example, controller 230, controllers 280, digital signal processor 720, and/or processor 704 shown in FIG. 2 and FIG. 7. Means 1102 may include, for example, the processing system 516 shown in FIG. 5. The exemplary means 1100 may include means for obtaining a first frame including an indication to use a first path with a second apparatus for at least a portion of an FTM session 1104. Means 1104 may include, for example, an interface (e.g., of a processor), antennas 224, antennas 252, receiver units 222, receiver units 254, RX spatial processor 240, RX spatial processors 260, RX data processor 242, RX data processors 270, controller 230, controllers 280, antennas 716, receiver 712, digital signal processor 720, and/or processor 704 shown in FIG. 2 and FIG. 7. Means 1104 may include, for example, the first interface 518a shown in FIG. 5. The exemplary means 1100 may include means for selecting, based on the indication to use the first path, the first set of antenna settings instead of the second set of antenna settings 1106. Means 1106 may include, for example, controller 230, controllers 280, digital signal processor 720, and/or processor 704 shown in FIG. 2 and FIG. 7. Means 1106 may include, for example, the processing system 516 shown in FIG. 5. The exemplary means 1100 may include means for obtaining, from the first apparatus using the first set of antenna settings, a second frame including acknowledgement information associated with a first FTM measurement frame of the plurality of FTM measurement frames and including one or more TRN fields 1108. Means 1108 may include, for example, an interface (e.g., of a processor), antennas 224, antennas 252, receiver units 222, receiver units 254, RX spatial processor 240, RX spatial processors 260, RX data processor 242, RX data processors 270, controller 230, controllers 280, antennas 716, receiver 712, digital signal processor 720, and/or processor 704 shown in FIG. 2 and FIG. 7. Means 1108 may include, for example, the first interface 518a shown in FIG. 5. The exemplary means 1100 may include means for generating a plurality of FTM measurement frames associated with the FTM session 1110. Means 1110 may include, for example, controller 230, controllers 280, digital signal processor 720, and/or processor 704 shown in FIG. 2 and FIG. 7. Means 1110 may include, for example, the processing system 516 shown in FIG. 5. The exemplary means 1100 may include means for outputting each FTM measurement frame of the plurality of FTM measurement frames for transmission using the first set of antenna settings 1112. Means 1112 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 716, transmitter 710, digital signal processor 720, and/or processor 704 shown in FIG. 2 and FIG. 7. Means 1102 may include, for example, the second interface 518b shown in FIG. 5. The exemplary means 1100 may include means for obtaining a third frame including an indication to use the second path instead of the first path after the FTM session 1114. Means 1114 may include, for example, an interface (e.g., of a processor), antennas 224, antennas 252, receiver units 222, receiver units 254, RX spatial processor 240, RX spatial processors 260, RX data processor 242, RX data processors 270, controller 230, controllers 280, antennas 716, receiver 712, digital signal processor 720, and/or processor 704 shown in FIG. 2 and FIG. 7. Means 1114 may include, for example, the first interface 518a shown in FIG. 5. The exemplary means 1100 may include means for selecting, based on the indication to use the second path, the second set of antenna settings for communication with the second apparatus after the FTM session 1116. Means 1116 may include, for example, controller 230, controllers 280, digital signal processor 720, and/or processor 704 shown in FIG. 2 and FIG. 7. Means 1116 may include, for example, the processing system 516 shown in FIG. 5. The exemplary means 1100 may further include means for receiving the first frame including the indication to use the first path with the second apparatus for at least a portion of an FTM session, which may include antennas 224, antennas 252, receiver units 222, receiver units 254, RX spatial processor 240, RX spatial processors 260, RX data processor 242, RX data processors 270, controller 230, controllers 280, antennas 716, receiver 712, digital signal processor 720, and/or processor 704 shown in FIG. 2 and FIG. 7. The exemplary means 1100 may further include means for transmitting each FTM measurement frame of the plurality of FTM measurement frames using the first set of antenna settings, which may include antennas 224, antennas 252, transmitter units 222, transmitter units 254, TX spatial processor 220, TX spatial processors 290, TX data processor 210, TX data processors 288, controller 230, controllers 280, antennas 716, transmitter 710, digital signal processor 720, and/or processor 704 shown in FIG. 2 and FIG. 7.

The various operations of methods described above may be performed by any suitable means capable of performing the operations. The means may include various hardware and/or software component(s) and/or module(s), including, but not limited to a circuit, an application specific integrated circuit (ASIC), or processor. Generally, any operations illustrated in the Figures may be performed by corresponding functional means capable of performing the operations.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term receiver may refer to an RF receiver (e.g., of an RF front end) or an interface (e.g., of a processor) for receiving structures processed by an RF front end (e.g., via a bus). Similarly, the term transmitter may refer to an RF transmitter of an RF front end or an interface (e.g., of a processor) for outputting structures to an RF front end for transmission (e.g., via a bus).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more operations or actions for achieving the described method. The method operations and/or actions may be interchanged with one another without departing from the scope of the claims. In other words, unless a specific order of operations or actions is specified, the order and/or use of specific operations and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, the apparatus comprising:
a processing system configured to:
identify a first set of antenna settings and a second set of antenna settings based on beamforming training with a second apparatus, the first set of antenna settings corresponding to a first path with the second apparatus different from a second path with the second apparatus corresponding to the second set of antenna settings, and
generate a first frame including an indication to use the first path instead of the second path for at least a portion of a fine timing measurement (FTM) session;
a first interface configured to output the first frame for transmission to the second apparatus; and
a second interface configured to obtain, from the second apparatus based on the first set of antenna settings, a plurality of FTM measurement frames associated with the at least the portion of the FTM session.

2. The apparatus of claim 1, wherein the first frame comprises a trigger field associated with the FTM session, and the indication to use the first path instead of the second path comprises a value of the trigger field.

3. The apparatus of claim 1, wherein:
the processing system is further configured to generate a second frame including acknowledgement information associated with a first FTM measurement frame of the plurality of FTM measurement frames and including one or more training (TRN) fields, and
the first interface is further configured to output the second frame for transmission to the second apparatus using the first set of antenna settings.

4. The apparatus of claim 3, wherein
a second FTM measurement frame of the plurality of FTM measurement frames indicates at least one of a time of arrival associated with the second frame or a time of departure associated with the first FTM measurement frame, and
the processing system is further configured to determine a position of the apparatus based at least partially on the at least one of the time of arrival or the time of departure.

5. The apparatus of claim 4, wherein:
the second FTM measurement frame indicates at least one of an angle of arrival associated with the second frame or an angle of departure associated with the second FTM measurement frame, and
the processing system is further configured to determine the position of the apparatus based at least partially on the at least one of the angle of arrival or the angle of departure.

6. The apparatus of claim 1, wherein:
the processing system is further configured to generate a third frame including an indication to use the second path instead of the first path after the FTM session, and
the first interface is further configured to output the third frame for transmission to the second apparatus.

7. The apparatus of claim 6, wherein the third frame comprises a contention-free (CF) end frame or an FTM request frame indicating termination of the FTM session.

8. An apparatus for wireless communication, the apparatus comprising:
a first interface configured to obtain a first frame including an indication to use a first path with a second apparatus for at least a portion of a fine timing measurement (FTM) session, the first path with the second apparatus different from a second path with the second apparatus;
a processing system configured to:
identify, based on beamforming training with the second apparatus, a first set of antenna settings corresponding to the first path with the second apparatus and a second set of antenna settings corresponding to the second path with the second apparatus,
select, based on the indication to use the first path, the first set of antenna settings instead of the second set of antenna settings, and
generate a plurality of FTM measurement frames associated with the FTM session; and
a second interface configured to output each FTM measurement frame of the plurality of FTM measurement frames for transmission using the first set of antenna settings.

9. The apparatus of claim 8, wherein:
the first frame comprises a trigger field associated with the FTM session,
the indication to use the first path instead of the second path comprises a value of the trigger field, and
the selection of the first set of antenna settings instead of the second set of antenna settings is based on the value of the trigger field.

10. The apparatus of claim 8, wherein:
the first interface is further configured to obtain, from the second apparatus using the first set of antenna settings, a second frame including acknowledgement information associated with a first FTM measurement frame of the plurality of FTM measurement frames and including one or more training (TRN) fields, and
the generation of the plurality of FTM measurement frames comprises generating a second FTM measurement frame that indicates at least one of a time of arrival associated with the second frame or a time of departure associated with the first FTM measurement frame.

11. The apparatus of claim 10, wherein:
the second FTM measurement frame indicates at least one of an angle of arrival associated with the second frame or an angle of departure associated with the second FTM measurement frame.

12. The apparatus of claim 8, wherein:
the first interface is further configured to obtain a third frame including an indication to use the second path instead of the first path after the FTM session,
the processing system is further configured to select, based on the indication to use the second path, the second set of antenna settings for communication with the second apparatus after the FTM session.

13. The apparatus of claim 12, wherein the third frame comprises a contention-free (CF) end frame or an FTM request frame indicating termination of the FTM session.

14-43. (canceled)

44. A wireless node configured for wireless communication, the wireless node comprising:
a processing system configured to:
identify a first set of antenna settings and a second set of antenna settings based on beamforming training with an apparatus, the first set of antenna settings corresponding to a first path with the apparatus different from a second path with the apparatus corresponding to the second set of antenna settings, and
generate a first frame including an indication to use the first path instead of the second path for at least a portion of an FTM session;
a transmitter configured to transmit the first frame to the apparatus; and
a receiver configured to receive, from the apparatus based on the first set of antenna settings, a plurality of FTM measurement frames associated with the at least the portion of the FTM session.

45. (canceled)

46. The apparatus of claim 8, further comprising:
a receiver configured to receive the first frame including the indication to use the first path with the second apparatus for at least a portion of an FTM session; and
a transmitter configured to transmit each FTM measurement frame of the plurality of FTM measurement frames using the first set of antenna settings,
wherein the apparatus is configured as a wireless node.
